(19) United States
(12) Patent Application Publication
(10) Pub. No.: US 2005/0094971 A1
(43) Pub. Date: May 5, 2005

(54) Data processing system and method

(75) Inventor: Stuart A. Green, Sheffield (GB)

Correspondence Address: WILMER CUTLER PICKERING HALE AND DORR LLP, 60 STATE STREET, BOSTON, MA, 02109, US

(73) Assignee: ZOOTech Limited, Sheffield (GB)

(21) Appl. No.: 10/756,975

(22) Filed: Jan. 14, 2004

(30) Foreign Application Priority Data
Nov. 4, 2003 (GB) GB 0325712.8

(51) Int. Cl. H04N 5/781

(52) U.S. Cl. 386/94; 386/125

(57) ABSTRACT

A method and system for creating an audiovisual product. The method has three main stages. The first stage defines components implicitly representing functional sections of audiovisual content and transitions that represent movements between components. The second stage expands the components and transitions to provide a set of explicitly realised AV assets and an expanded intermediate data structure of nodes and links. Each node is associated with one of the AV assets and the links represent movement from one node to another. The third stage creates the audiovisual product in a predetermined output format, using the AV assets and the expanded intermediate data structure of the nodes and the links, wherein the audiovisual product comprises data representing a menu.

### FIELD OF THE INVENTION

The present invention relates in general to a data processing method and system.

### BACKGROUND OF THE INVENTION

In general terms, it is desired to assemble many small sections of raw audio and video content (i.e. sound clips and video clips) to form a finished audiovisual product, by way of an authoring process. However, in many environments a considerable degree of specialist knowledge and time must be invested in the authoring process in order to achieve a desirable finished audiovisual product. These problems are exacerbated where the audiovisual product has a complex navigational structure or requires many separate raw content objects.

As a simple example, a feature movie or television program typically has a straightforward linear navigational sequence of individual scenes. By contrast, it is now desired to develop new categories of audiovisual products which have a much more complex navigational structure, such as a movie with many scene choices or different movie endings, and/or which have a large number of individual scenes, such as an interactive quiz game with say one thousand individual quiz questions.

An optical disc is a convenient storage media for many different purposes. A digital versatile disc (DVD) has been developed with a capacity of up to 4.7 Gb on a single-sided single-layer disc, and up to 17 Gb on a double-sided double-layer disc. There are presently several different formats for recording data onto a DVD disc, including DVD-video, DVD-audio, and DVD RAM, amongst others. Of these, DVD-video is particularly intended for use with pre-recorded video content, such as a motion picture. As a result of the large storage capacity and ease of use, DVD discs are becoming popular and commercially important. Conveniently, a DVD-video disc is played using a dedicated playback device with relatively simple user controls, and DVD players for playing DVD-video discs are becoming relatively widespread. More detailed background information concerning the DVD-video specification is available from DVD Forum at www.dvdforum.org.

Although DVD-video discs and DVD-video players are becoming popular and widespread, at present only a limited range of content has been developed. In particular, a problem arises in that, although the DVD specification is very flexible, it is also very complex. The process of authoring content into a DVD-video compatible format is relatively expensive and time consuming. In practice, the flexibility and functions allowed in the DVD-video specification are compromised by the expensive and time consuming authoring task. Consequently, current DVD-video discs are relatively simple in their navigational complexity. Such simplicity can impede a user's enjoyment of a DVD-video disc, and also inhibits the development of new categories of DVD-video products.

An example DVD authoring tool is disclosed in WO 99/38098 (Spruce Technologies) which provides an interactive graphical authoring interface and data management engine. This known authoring tool requires a relatively knowledgeable and experienced operator and encounters difficulties when attempting to develop an audiovisual product having a complex navigational structure. In particular, despite providing a graphical user interface, the navigational structure of the desired DVD-video product must be explicitly defined by the author. Hence, creating a DVD-video product with a complex navigational structure is expensive, time-consuming and error-prone.

DVDs represent one of the fastest growing forms of multimedia entertainment throughout the world. Conventionally, DVDs have been used to present movies to users using extremely high quality digital audio/visual content. FIG. 14 shows, schematically, a typical home entertainment system 1400 comprising a DVD player 1402, a DVD 1404 and a television 1406. The DVD 1404 contains a number of programs and cells 108 each of which comprises corresponding digital audio-visual content 1410 together with respective navigation data 1412. The navigation data 1412 is used by a navigation engine 1414 within the DVD player 1402 to control the order or manner of presentation of the digital content 1410 by a presentation engine 1416.

The presentation engine 1416 presents the digital content 1410 on a television or monitor 1406 as rendered audio-visual content 1418. As is well known within the art, the rendered audio-visual content 1418, conventionally, takes the form a movie or photographic stills or text associated with that movie; so-called Bonus features.

A user (not shown) can use a remote control 1420 associated with the DVD player 1402 to influence the operation of the navigation engine 1414 via an infrared remote control interface 1422. The combination of the infrared remote control 1420 and the navigation engine 1414 allows the user to make various selections from any menus presented by the presentation engine 1416 under the control of the navigation engine 1414 as mentioned above.

Due to the relatively limited set of commands that might form the navigation data, the processing performed by the DVD player and, in particular, the navigation engine 1414, is relatively simple and largely limited to responding to infrared remote control commands and retrieving and displaying, via the presentation engine 1416, pre-authored or pre-determined digital audio-visual content 1410. Beyond decoding and presenting the digital audio-visual content 1410 as rendered visual content 1418, the DVD player 1402 performs relatively little real-time processing.

This can be contrasted with the relatively sophisticated real-time processing performed by computers when providing or supporting a graphical user interface (GUI) such as that represented or presented by all of the members of the family of Windows operating systems available from Microsoft Corporation. FIG. 15 depicts, schematically, a GUI 1500 presented by, for example, Internet Explorer, running on the Windows 98 operating system. The GUI 1500 comprises an application window 1502 with a menu bar 1504. The menu bar 1504 has a number of menu items 1506 to 1516 that can be selected individually using a mouse and cursor or corresponding hot-keys as is well known within the art. Selecting one of the menu items 1506 to 1516, typically, causes a pull-down menu to be displayed. FIG. 16 depicts a pull-down menu 1600 corresponding to the “File” menu item 1506. It can be seen that the pull-down menu 1600 comprises a number of further menu items, “New” 1602 to “Close” 1604, that can be selected to perform corresponding functions. Two of the further menu items; namely, “New” 1602 and “Send” 1606 invoke or produce further, respective, menus (not shown)

As will be appreciated, the menu items are selected and the various menus, pull-down or otherwise, are invoked in real-time, that is, the processing necessary for displaying and stepping through the various menu items presented is performed in real-time. Effectively, the instruction set of a microprocessor of a host computer is sufficiently sophisticated and flexible to imbue the Internet Explorer application 1500 with the capability to perform the necessary calculations and manipulations to implement the display and selection of menu items in response to user commands issued in real-time.

It will be appreciated that this is in stark contrast to the operation of menus and the selection of menu items using current DVD players. As compared to computer applications, the menu options and the mode of presentation of those options of those DVD players is currently relatively crude and unsophisticated. This is, at least in part, due to most DVD players being unable to perform, in response to a user action or command, the real-time processing necessary to display such sophisticated menus and, subsequently, to select a menu item from such displayed menus. This is due, in part, to the very limited additional graphics element processing capacity offered by current DVD players.

It will be appreciated that the panes illustrated in FIGS. 15 and 16 have been shown as lacking content. The limitations of DVD players become even more apparent when considering providing dynamic menus with content that can change or is dynamic. For example, the content displayable within a pane might be video or stills of digital images such as photographs or the like.

It is an object of embodiments of the present invention at least to mitigate some of the problems of the prior art.

### SUMMARY OF THE INVENTION

In a first aspect of the present invention there is provided an authoring method for use in creating an audiovisual product, comprising the steps of: defining a plurality of components, the components implicitly representing functional sections of audiovisual content with respect to one or more raw content objects, and a plurality of transitions that represent movements between the plurality of components; expanding the plurality of components and the plurality of transitions to provide a set of explicitly realised AV assets and an expanded intermediate data structure of nodes and links, where each node is associated with an AV asset of the set and the links represent movement from one node to another; and creating an audiovisual product in a predetermined output format, using the AV assets and the expanded intermediate data structure of the nodes and the links, wherein the audiovisual product comprises data representing or capable of emulating at least one menu.

In one preferred embodiment, the present invention relates to authoring of audiovisual content into a form compliant with a specification for,DVD-video and able to be recorded on an optical disc recording medium.

In a second aspect of the present invention there is provided an authoring method for use in creating a DVD-video product, comprising the steps of: creating a plurality of components representing parameterised sections of audiovisual content, and a plurality of transitions representing movements between components; expanding the plurality of components and the plurality of transitions to provide a set of AV assets and an expanded data structure of nodes and links, where each node is associated with an AV asset of the set and the links represent movement from one node to another; and creating a DVD-video format data structure from the AV assets, using the nodes and links, wherein the DVD-video format data structure comprises data representing, or capable of emulating, at least one menu.

In a third aspect of the present invention there is provided an authoring method for use in creating an audiovisual product according to a DVD-video specification, comprising the steps of: generating a set of AV assets each comprising a video object, zero or more audio objects and zero or more sub-picture objects, and an expanded data structure of nodes and links, where each node is associated with one AV asset of the set and the links represent navigational movement from one node to another; and creating a DVD-video format data structure from the set of AV assets, using the nodes and links; the method characterised by the steps of: creating a plurality of components and a plurality of transitions, where a component implicitly defines a plurality of AV assets by referring to a presentation template and to items of raw content substitutable in the presentation template, and the plurality of transitions represent navigational movements between components; and expanding the plurality of components and the plurality of transitions to generate the set of AV assets and the expanded data structure of nodes and links, wherein the set of AV assets and the expanded data structure of nodes and links comprises data representing, or capable of emulating, a menu.

In another aspect the present invention there is provided a recording medium having recorded thereon computer implementable instructions for performing any of the methods defined herein.

In yet another aspect of the present invention there is provided a recording medium having recorded thereon an audiovisual product authored according to any of the methods defined herein.

Advantageously, embodiments can provide a convenient and simple method and apparatus for authoring an audio-visual product.

Preferred embodiments provide a method and apparatus able to create an audio-visual product having a complex navigational structure and/or having many individual content objects, whilst reducing a time required for authoring and minimising a need for highly skilled operators.

Preferably, there is provided an authoring tool that is intuitive to use and is highly flexible.

Particularly preferred embodiments support creation of audio-visual products such as DVD-video products that run on commonly available DVD-video players.

According to a further aspect of embodiments there is provided an asset authoring method comprising the steps of providing a data structure comprising data defining a menu structure having at least one menu having a respective number of menu items associated with a number of defined views of, or actions in relation to, a general visual asset; providing a visual asset; and creating, automatically, a number of visual assets using at least one of the visual assets provided and the data of the data structure; the visual assets created corresponding to respective views of the defined views of the visual asset provided or reflecting respective actions of the defined actions in relation to the visual asset provided.

Advantageously, embodiments of the present invention allow menus, in particular, pull-down menus, associated with viewing content to be realised on a DVD player, that is, the embodiments allow the real-time display of menus and invocation of menu items performed by computers to be at least emulated.

A further aspect of embodiments of the present invention provides a method of authoring visual content; the method comprising the step of creating a video sequence comprising data to display a progressively expanding menu comprising a number of menu items following invocation of a selected menu item or a user-generated event. A still further aspect of embodiments of the present invention provides a method of authoring visual content; the method comprising the step of creating a video sequence comprising data to display a progressively contracting menu comprising a number of menu items following invocation of a selected menu item or a user generated event.

### BRIEF DESCRIPTION OF THE DRAWINGS

Embodiments of the present invention will now be descried, by way of example only, with reference to the accompanying drawings in which:

FIG. 1 is an overview of an authoring method according to a preferred embodiment;

FIG. 2 is a schematic diagram showing a simple abstraction of a desired audiovisual product;

FIG. 3 shows in more detail a component used as part of the abstraction of FIG. 2;

FIG. 4 illustrates an example prior art authoring method compared with an example preferred embodiment;

FIG. 5 depicts another example embodiment of the present authoring method using components and transitions;

FIG. 6 shows the example of FIG. 5 in a tabular format;

FIG. 7 is an overview of a method for evaluating components and transitions;

FIG. 8 depicts evaluation of components in more detail;

FIG. 9 shows evaluation of transitions in more detail;

FIG. 10 illustrates a portion of an expanded data structure during evaluation of components and transitions;

FIG. 11 is an overview of a preferred method for creating DVD-video structures from an expanded data structure;

FIG. 12 shows a step of creating DVD video structure locations in more detail;

FIG. 13 depicts a step of creating DVD-video compatible data structures in more detail;

FIG. 14 shows a home entertainment system;

FIG. 15 shows a GUI for Internet Explorer;

FIG. 16 depicts a pull-down menu of the GUI;

FIG. 17 shows schematically an asset authoring process according to an embodiment of the present invention;

FIG. 18 depicts a data structure for defining a menu according to an embodiment;

FIG. 19 shows, schematically, video sequences for expansion and contraction of pull-down menus according to embodiments of the present invention;

FIG. 20 illustrates data for a pull-down menu to be used in the video sequences of FIG. 19;

FIG. 21 illustrates the generation of sub-picture menu data for the pull-down menus used in the video sequences of FIG. 19;

FIG. 22 depicts a further relationship between sub-picture menu data and corresponding menu items;

FIG. 23 shows the relationship between a sub-picture having menu item overlays and a corresponding video sequence or frame;

FIG. 24 illustrates the frames of a video sequence for the expansion and contraction of the menu;

FIG. 25 illustrates the generation of a further menu item according to an embodiment;

FIG. 26 shows menu data for generating a video sequence showing the progressive expansion or contraction of the further menu shown in FIG. 25;

FIG. 27 depicts the relationship between a graphical overlay of a sub-picture to a corresponding menu item of the further menu shown in FIG. 25;

FIG. 28 shows a first flowchart for generating a visual asset according to an embodiment; and

FIG. 29 shows a second flowchart for generating a visual asset according to an embodiment.

### DETAILED DESCRIPTION OF THE PREFERRED EMBODIMENTS

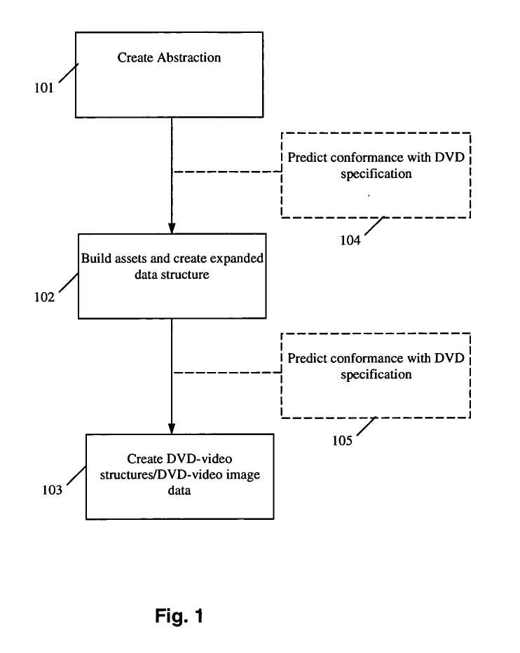

FIG. 1 shows an overview of an authoring method according to a preferred embodiment of the present invention. The embodiments of the present invention are applicable when authoring many types of audiovisual content or products, and in particular when complex navigational structure or content are involved.

As one example, embodiments of the present invention are applicable to authoring of video-on-demand products delivered remotely from a service provider to a user, such as over a computer network or other telecommunications network. Here, the embodiments of present invention are especially useful in authoring interactive products, where user choices and responses during playback of the product dictate navigational flow or content choices.

As another example, embodiments of the present invention are particularly suitable for use in the authoring of an audiovisual product or audio visual content compliant with a DVD-video specification. This example will be discussed in more detail below in order to illustrate the preferred arrangements of present invention. The audiovisual product or content can be, for example, recorded onto a medium such as an optical disk or magnetic medium. The DVD-video specification defines a series of data objects that are arranged in a hierarchical structure, with strict limits on the maximum number of objects that exist at each level of the hierarchy. Hence, in one preferred embodiment of the present invention it is desired to create an audiovisual product or audiovisual content which meets these and other limitations of the specification. In particular it is desired that the resultant audiovisual product or content will play on commonly available DVD players. However, it is also desired to create the audiovisual product or content having a complex navigational structure, to increase a user's enjoyment of the product, and in order to allow the creation of new categories of audiovisual products.

In the field of DVD-video, audiovisual content is considered in terms of audio-visual assets (also called AV assets or presentation objects) . According to the DVD-video specification each AV asset contains at least one video object, zero or more audio objects, and zero or more sub-picture objects. That is, a section of video data is presented along with synchronised audio tracks and optional sub-picture objects. The current DVD-video specification allows up to eight different audio tracks (audio streams) to be provided in association with up to nine video objects (video streams). Typically, the video streams represent different camera angles, whilst the audio streams represent different language versions of a soundtrack such as English, French, Arabic etc. Usually, only one of the available video and audio streams is selected and reproduced when the DVD-video product is played back. Similarly, the current specification allows up to thirty-two sub-picture streams, which are used for functions such as such as language subtitles. Again, typically only one of the sub-picture streams is selected and played back to give, for example, a movie video clip with English subtitles from the sub-picture stream reproduced in combination with a French audio stream. Even this relatively simple combination of video, audio and sub-picture streams requires a high degree of co-ordination and effort during authoring to achieve a finished product such as a feature movie. Hence, due to the laborious and expensive nature of the authoring process there is a strong disincentive that inhibits the development of high-quality audiovisual products or content according to the DVD-video specification. There is then an even stronger impediment against the development of audiovisual products or content with complex navigational flow or using high numbers of individual raw content objects.

Conveniently, the authoring method of embodiment of the present invention are implemented as a program or a suite of programs. The program or programs are recorded or stored on or in any suitable medium, including a removable storage such as a magnetic disk, hard disk or solid state memory card, or as a signal modulated onto a carrier for transmission on any suitable data network, such as the Internet.

In use, the authoring method is suitably performed on a computing platform, like a general purpose computing platform such as a personal computer or a client-server computing network. Alternatively, the method may be implemented, wholly or at least in part, by dedicated authoring hardware.

As shown in FIG. 1, the authoring method of the preferred embodiment of the present invention comprises three main stages, namely: creating a high-level abstraction (or storyboard) representing functional sections of a desired audiovisual product in step 101; automatically evaluating the high-level abstraction to create a fully expanded intermediate structure and a set of AV assets in step 102; and creating an output data structure compliant with a DVD-video specification using the expanded intermediate structure and AV assets in step 103. Preferably, the output data structure can then recorded onto a recording medium, such as, for example, a digital linear tape that can be used, to create a DVD-video product using glass master created using the content of the digital linear tape.

The method outlined in FIG. 1 will now be explained in more detail.

Firstly, looking at the step 101 of FIG. 1, the high-level abstraction is created by forming a plurality of components that implicitly represent functional elements of a desired DVD-video product or content, and a set of transitions that represent movements, that is, navigation, between the components that will occur during playback.

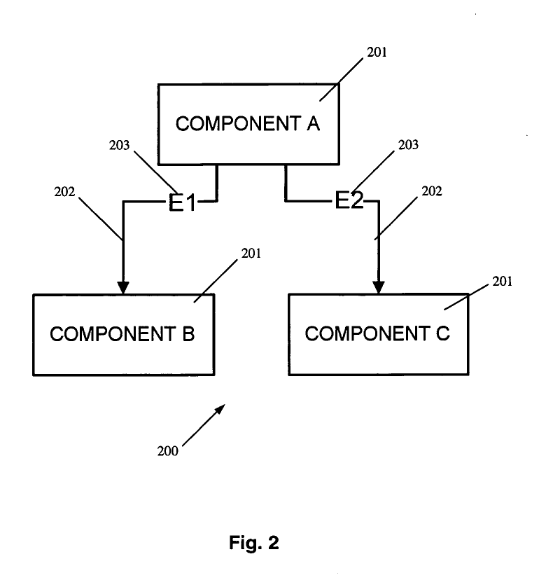

FIG. 2 is a schematic diagram showing a simple abstraction of a desired audiovisual product or content. In the example of FIG. 2 there are three components 201, linked by two transitions 202. The components 201 represent functional elements of the desired audiovisual product, where one or more portions of AV content (combinations of video clips, audio clips, etc) are to be reproduced during playback. The transitions 202 indicate legitimate ways of moving from one component to another during playback. In the example of FIG. 2, the transitions 202 are all explicitly defined. Suitably, each transition 202 is associated with an event 203, which indicates the circumstances giving rise to that transition. An event 203 is a triggering action such as the receipt of a user command, or the expiry of a timer, that influences movement through the sections of AV content during playback. Referring to FIG. 2, starting from a particular component A, and given all possible actions, exactly one event 203 will be satisfied, allowing a transition 202 from the current component A to a next component B or C.

The preferred embodiments provide three different types of component. These are an information component, a choice component and a meta-component.

An information component represents what will in due course become a single AV asset in the desired audiovisual product. Suitably, an information component simply comprises a reference to a raw content object or collection of raw content objects (i.e. raw video and audio clips, image stills or other digital content) that will be used to create an AV asset in the audiovisual product. For example, an information component refers to a welcome sequence that is displayed when the DVD-video product is played in a DVD-video player. The same welcome sequence is to be played each time playback begins. It is desired to display the welcome sequence, and then proceed to the next component. An information component (which can also be termed a simple component) is used principally to define presentation data in the desired DVD-video product.

A choice component represents what will become a plurality of AV assets in the desired audiovisual product. In the preferred embodiment, the choice component (alternately termed a multi-component) comprises a reference to at least one raw content object, and one or more parameters. Here, for example, it is desired to present a welcome sequence in one of a plurality of languages, dependent upon a language parameter. That is, both a speaker's picture (video stream) and voice track (audio stream) are changed according to the desired playback language. Conveniently, a choice component is used to represent a set of desired AV assets in the eventual audiovisual product or content, where a value of one or more parameters is used to distinguish between each member of the set. Hence, a choice component represents mainly presentation data in a desired DVD-video product or content, but also represents some navigational structure (i.e. selecting amongst different available AV assets according to a language playback parameter).

A meta-component comprises a procedurally-defined structure representing a set of information components and/or a set of choice components, and associated transitions. Conveniently, a meta-component may itself define subsidiary meta-components. A meta-component is used principally to define navigational structure in the desired audiovisual product by representing other components and transitions.

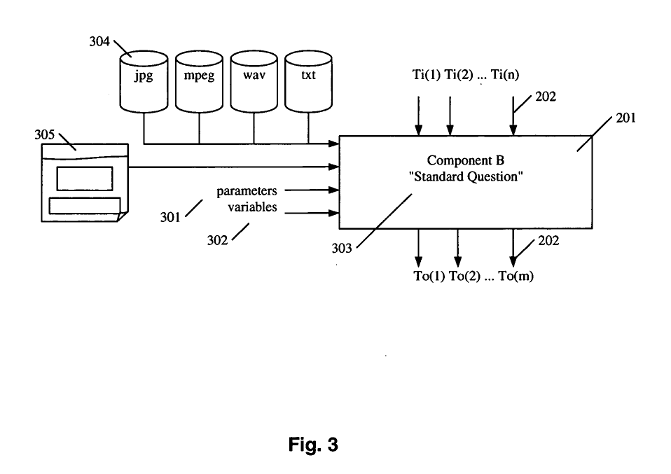

FIG. 3 shows a choice component or information component 201 in more detail. The component is reached by following one of a set of incoming transitions 202, labelled Ti (1 . . . n), and is left by following one of a set of outgoing transitions To (1 . . . m). The set of incoming transitions 202 might comprise one or more than one incoming transition. The set of outgoing transitions might comprise one or more than one outgoing transition.

The component 201 is defined with reference to zero or more parameters 301, which are used only during the authoring process. However, the component 201 may also be defined with reference to zero or more runtime variables 302. Each variable 302 records state information that can be read and modified within the scope of each component, during playback of the audiovisual product or content such as in a standard DVD player. Conveniently, the component 201 is provided with a label 303 for ease of handling during the authoring process.

The component 201 contains references to one or more items of content 304. The items of content are raw multi-media objects (still picture images, video clips, audio clips, text data, etc.) recorded in one or more source storage systems such as a file system, database, content management system, or asset management system, in any suitable format such as, for example, .gif, .tif, .bmp, .txt, .rtf, .jpg, .mpg, .qtf, .mov, .wav, .rm, .qtx, amongst many others. It will be appreciated that these raw content objects are not necessarily at this stage in a format suitable for use in the DVD-video specification, which demands that video, audio and sub-picture objects are provided in selected predetermined formats (i.e. MPEG).

Each component 201 uses the references as a key or index which allows that item of content to be retrieved from the source storage systems. The references may be explicit (e.g. an explicit file path), or may be determined implicitly, such as with reference to values of the parameters 301 and/or variables 302 (i.e. using the parameters 301 and/or variables 302 to construct an explicit file path).

Conveniently, the component 201 also preferably comprises a reference to a template 305. The template 305 provides, for example, a definition of presentation, layout, and format of a desired section of AV content to be displayed on screen during playback. A template 305 draws on one or more items of content 304 to populate the template. Typically, one template 305 is provided for each component 201. However, a single template 305 may be shared between a number of components 201 or vice versa. A template 305 is provided in any suitable form, such as, for example. As an executable program, a plug-in or an active object. A template is conveniently created using a programming language such as C++, Visual Basic, Shockwave or Flash, or by using a script such as HTML or Python, amongst many others. Hence, it will be appreciated that a template allows a high degree of flexibility in the creation of AV assets for a DVD-video product or content. Also, templates already created for other products (such as a website) may be reused directly in the creation of another form of audiovisual product or content, in this case a DVD-video product content.

The parameters 301, runtime variables 302, content items 304 and template 305 together allow one or more AV assets to be produced for use in the desired audiovisual product. Advantageously, creating a component 201 in this parameterised form allows a number, which might be a large number, large plurality of AV assets to be represented simply and easily by a single component.

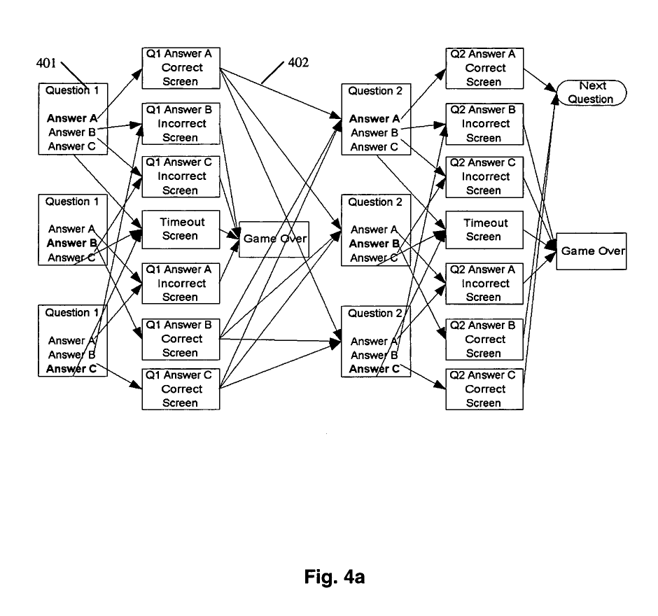

To illustrate the power and advantages of creating components 201 and transitions 202 as described above, reference will now be made to FIG. 4 which compares a typical prior art method for authoring an audiovisual product or content against preferred embodiments of the present invention. In this example, it is desired to develop an audiovisual product which allows the user to play a simple quiz game.

In FIG. 4a, each AV asset 401 which it is desired to present in the eventual audiovisual product must be created in advance and navigation between the assets defined using navigation links represented by arrows 402. Here, the game involves answering a first question and, if answered correctly, then answering a second question. The answer to each question is randomised at runtime using a runtime variable such that one of answers A, B and C is correct, whilst the other two are incorrect. In this simple example of FIG. 4a it can be seen that a large number of assets need to be created, with an even greater number of navigational links. Hence, the process is relatively expensive and time consuming, and is prone to errors.

FIG. 4b shows an abstraction, using components and transitions as described herein, for an equivalent quiz game. It will be appreciated that the abstraction shown in FIG. 4b remains identical even if the number of questions increases to ten, twenty, fifty or some other number of questions, whereas the representation in FIG. 4a becomes increasingly complex as each question is added.

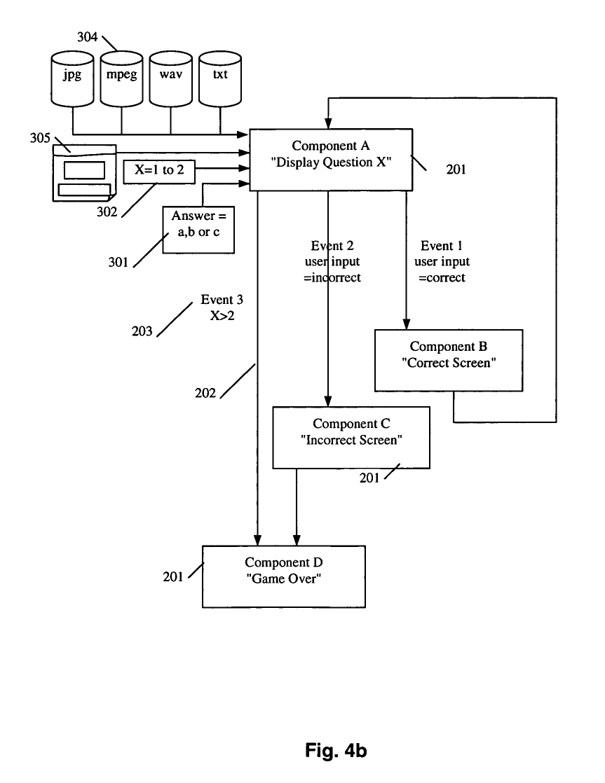

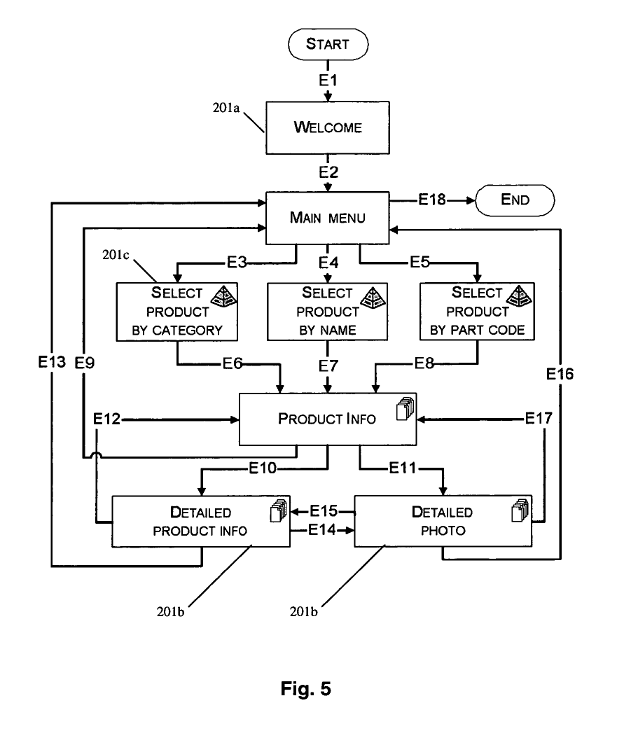

FIG. 5 shows another example abstraction using components and transitions. FIG. 5 illustrates an example abstraction for an audiovisual product or content that will contain a catalogue of goods sold by a retail merchant. A welcome sequence is provided as an information component 201a. Choice components 201b are used to provide a set of similar sections of AV content such as summary pages of product information or pages of detailed product information including photographs or moving video for each product in the catalogue. Here, the catalogue contains, for example, of the order of one thousand separate products, each of which will result in a separate AV asset in the desired DVD-video product. Meta-components 201c provide functions such as the selection of products by category, name or by part code. These meta-components are procedurally defined.

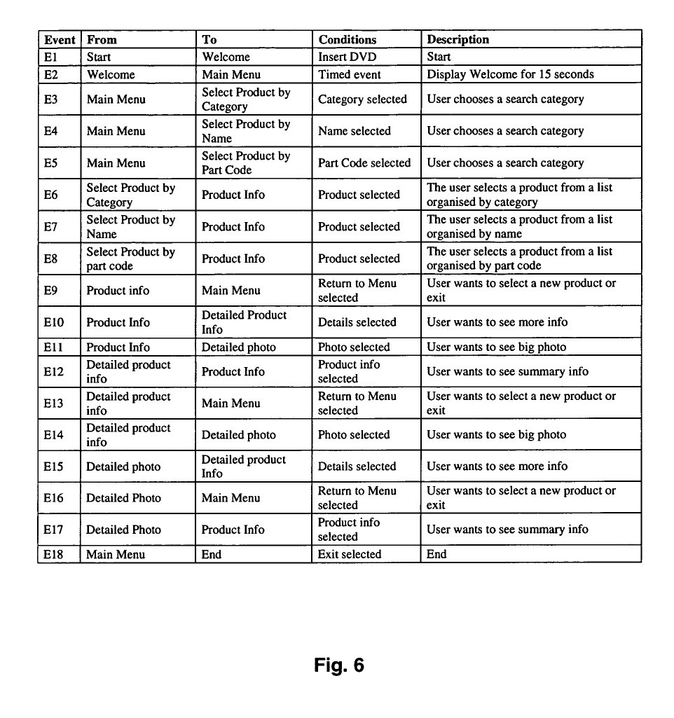

FIG. 6 shows a tabular representation for the abstraction shown in schematic form in FIG. 5.

In use, the authoring method and apparatus suitably presents a convenient user interface for creating components and transitions of the high-level abstraction. Ideally, a graphical user interface is provided allowing the definition of components, transitions and events, similar to the schematic diagram of FIG. 5. Most conveniently, the user interface provides for the graphical creation of components such as by drawing boxes and entering details associated with those boxes, and defining transitions by drawing arrows between the boxes and associating events with those arrows. Alternatively, a tabular textual interface is provided similar to the table of FIG. 6.

Referring again to FIG. 1, the abstraction created in step 101 is itself a useful output. The created abstraction may be stored for later use or may be transferred to another party for further work. However, in most cases the authoring method is used to automatically create a final audiovisual product or content, such as a DVD-video product, from the abstraction.

Referring to FIG. 1, the method optionally includes the step 104 of checking for compliance with a DVD specification. It is desired to predict whether the resulting DVD-video product will conform to a desired output specification, in this case the DVD-video specification. For example, the DVD-video specification has a hierarchical structure with strict limits on a maximum number of objects that may exist at each level, and limits on the maximum quantity of data that can be stored on a DVD-video disc.

In one embodiment, the checking step 104 is performed using the created components 201 and transitions 202. As discussed above, the components 201 contain references to raw AV content objects 304 and templates 305, and authoring parameters 301, 302, that allow AV assets to be produced. The checking step 104 comprises predicting a required number of objects at each level of the hierarchical structure, by considering the number of potential AV assets that will be produced given the possible values of the authoring parameters (i.e. authoring-only parameters 301 and runtime variables 302), and providing an indication of whether the limits for the maximum number of objects will be exceeded. Similarly, where a component defines a set of similar AV assets, then it is useful to predict the physical size of those assets and to check that the audiovisual product or content is expected to fit within the available capacity of a DVD disc. Advantageously, the conformance check of step 104 is performed without a detailed realisation of every AV asset, whilst providing an operator with a reasonably accurate prediction of expected conformance. If non-conformance is predicted, the operator may then take steps, at this early stage, to remedy the situation. As a result, it is possible to avoid unnecessary time and expense in the preparation of a full audiovisual product which is non-conformant.

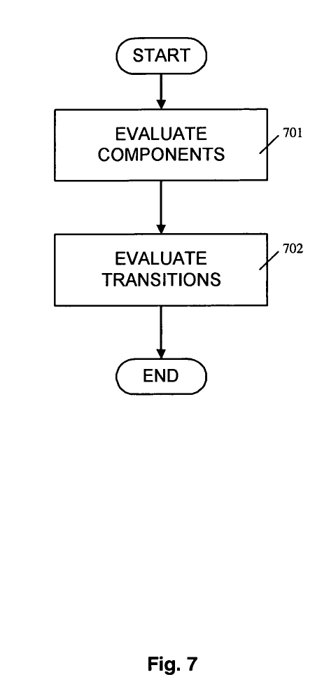

As shown in FIG. 1, in step 102 the components 201 and transitions 202 of the high level abstraction 200 are automatically evaluated and expanded to create AV assets and an intermediate data structure of nodes and links. FIG. 7 shows the step 102 of FIG. 1 in more detail.

The components 201 and transitions 202 may be evaluated in any order. However, but it is convenient to first evaluate the components and then to evaluate the transitions. Ideally, any meta-components in the abstraction are evaluated first. Where a meta-component results in new components and transitions, these are added to the abstraction until all meta-components have been evaluated, leaving only information components and parameterised choice components.

An expanded intermediate data structure is created to represent the abstract components 201 and transitions 202 in the new evaluated form. This expanded data structure comprises branching logic derived from the events 203 attached to the transitions 202 (which will eventually become navigation data in the desired audiovisual product or content) and nodes associated with AV assets derived from the components 201 (which will eventually become presentation data in the audiovisual product or content) However, it is not intended that the expanded data structure is yet in a suitable form for creating an audiovisual product in a restricted format such as a DVD-video product, since at this stage there is no mapping onto the hierarchical structure and other limitations of the DVD-video specification.

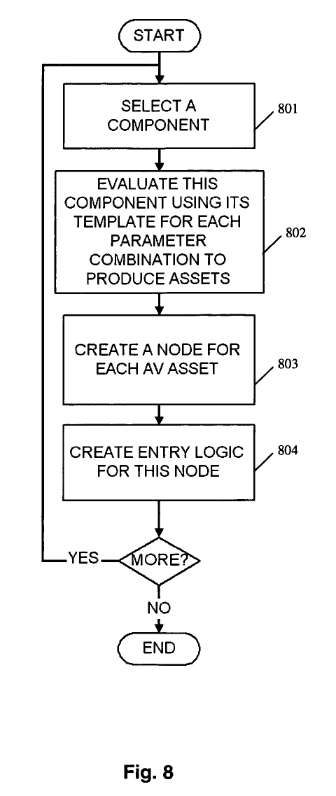

FIG. 8 shows step 701 of FIG. 7 in more detail, to explain the preferred method for evaluating the components 201. As shown in FIG. 8, each information component 201a and each choice component 201b is selected in turn in step 801. Each component 201 is evaluated to provide one or more AV assets in step 802. In an information component, this evaluation comprises creating an AV asset from the referenced raw content objects 304. In a choice component, this evaluation step comprises evaluating a template 305 and one or more raw content objects 304 according to the authoring parameters 301/302 to provide a set of AV assets. Suitably, a node in the expanded data structure is created to represent each AV asset, at step 803. At step 804, entry logic and/or exit logic is created to represent a link to or from each node such that each AV asset is reached or left under appropriate runtime conditions.

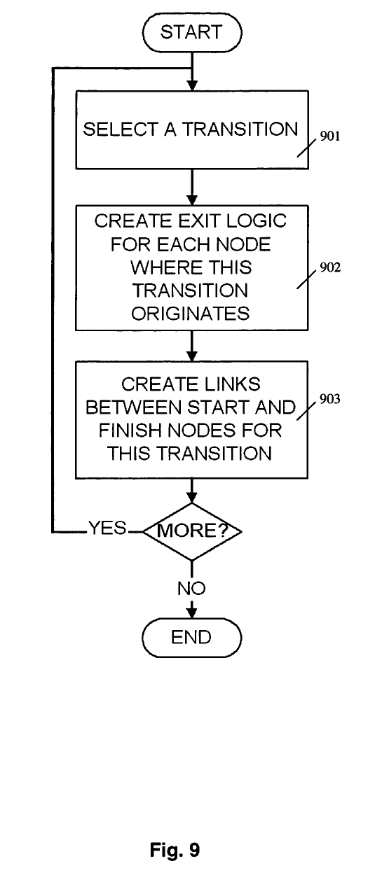

FIG. 9 shows a preferred method for evaluating transitions in step 702 of FIG. 7. Each transition 202 is selected in any suitable order in step 901. In step 902 the conditions of the triggering event 203 associated with a particular transition 202 are used to create entry and/or exit logic for each node of the expanded data structure. In step 903, explicit links are provided between the nodes.

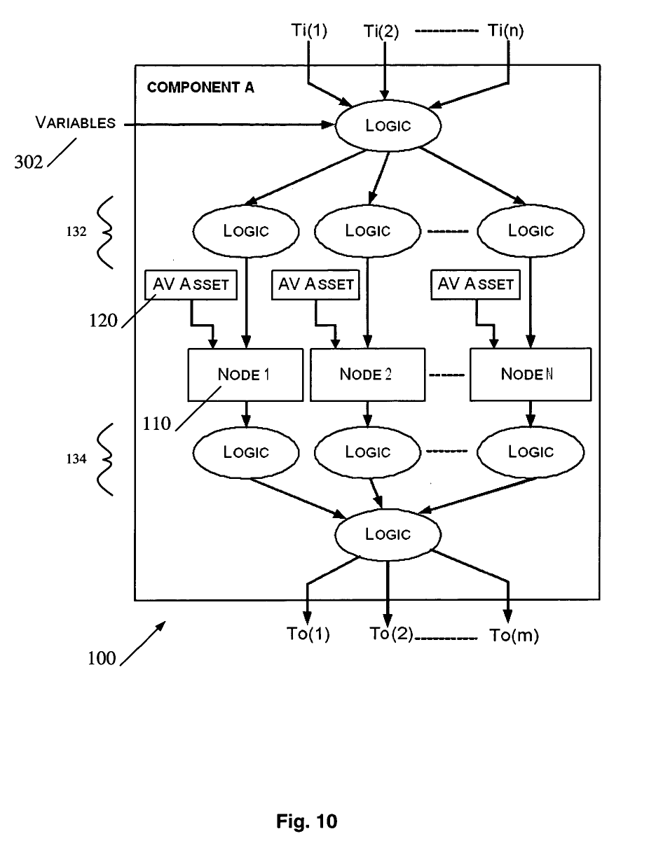

FIG. 10 is a schematic illustration of a component 201 during evaluation to create a set of nodes 110 each associated with an AV asset 120, together with entry logic 132 and exit logic 134, defining movement between one node 110 and the next. The entry logic 132 and exit logic 134 reference runtime variables 302 which are available during playback (e.g. timer events, player status, and playback states), and the receipt of user commands. Conveniently, the evaluation step consumes each of the authoring-only parameters 301 associated with the abstract components 201, such that only the runtime variables 302 and runtime actions such as timer events and user commands remain.

Referring again to FIG. 1, a conformance checking step 105 may, additionally or alternatively to the checking step 104, be applied following the evaluation step 102. Evaluation of the abstraction in step 102 to produce the expanded data structure 100 allows a more accurate prediction of expected compliance with a particular output specification. In particular, each node of the expanded data structure represents one AV asset, such that the total number of AV assets and object locations can be accurately predicted, and the set of AV assets has been created, allowing an accurate prediction of the capacity required to hold these assets. Conveniently, information about conformance or non-conformance is fed back to an operator. Changes to the structure of the product can then be suggested and made in the abstraction to improve compliance.

Referring to FIG. 1, in step 103 the expanded data structure from step 102 is used to create an audiovisual product according to a predetermined output format, in this case by creating specific structures according to a desired DVD-video specification.

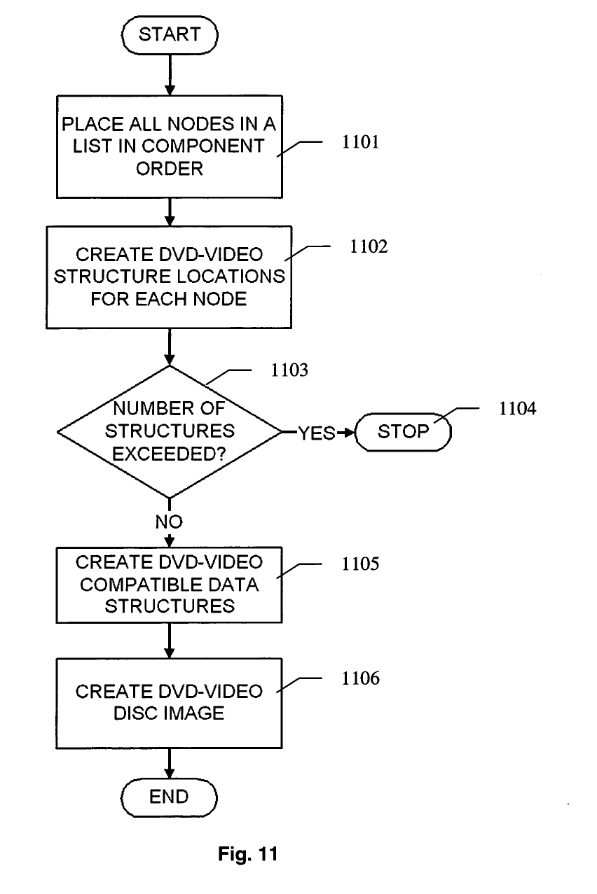

FIG. 11 shows an example method for creation of the DVD video structures. In step 1101, the nodes 110 in the expanded data structure are placed in a list, such as in an order of the abstract components 201 from which those nodes originated, and in order of the proximity of those components to adjacent components in the abstraction. As a result, jumps between DVD video structure locations during playback are minimised and localised to improve playback speed and cohesion.

Each node is used to create a DVD video structure location at step 1102. Optionally, at step 1103 if the number of created DVD video structure locations exceeds the specified limit set by the DVD-video specification then creation is stopped at 1104 and an error reported. Assuming the number of structures is within the specified limit then DVD video compatible data structures are created at step 1105. Finally, a DVD video disc image is created at step 1106. Conveniently, commercially available tools are used to perform step 1106 and need not be described in detail here.

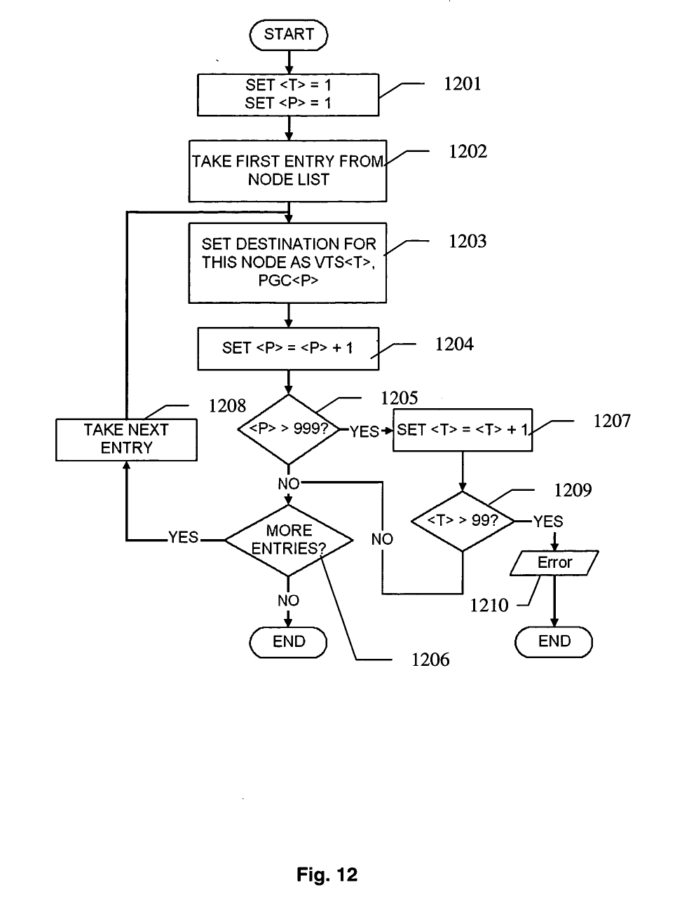

Step 1102 is illustrated in more detail in FIG. 12. In this example variable T represents a number of a video title set VTS (ie. from 1-99) whilst variable P represents a program chain PGC (ie. from 1-999) within each video title set. As shown in FIG. 12, the nodes 110 of the expanded data structure 100 are used to define locations in the video title sets and program chains. As the available program chains within each video title set are consumed, then the locations move to the next video title set. Here, many alternate methods are available in order to optimise allocation of physical locations to the nodes of the expanded data structure.

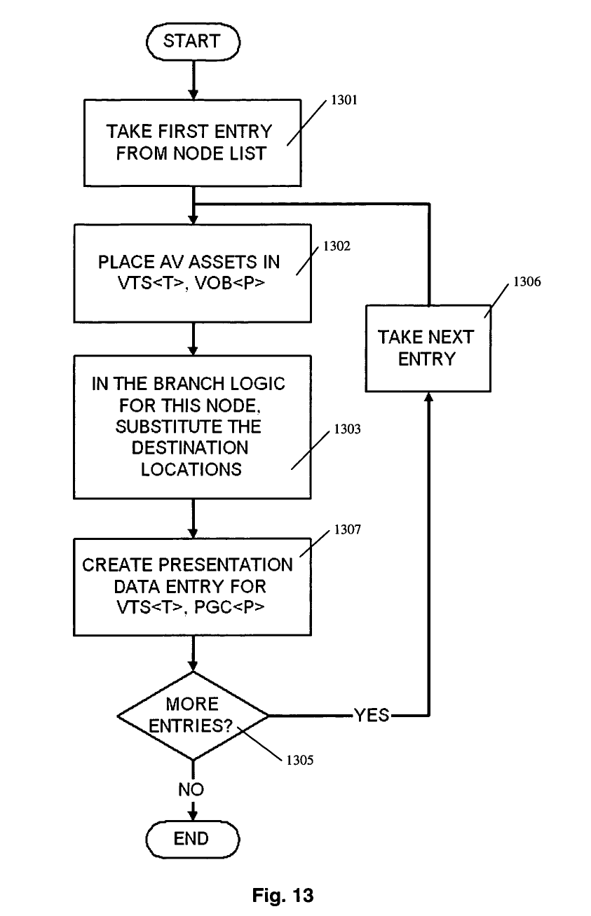

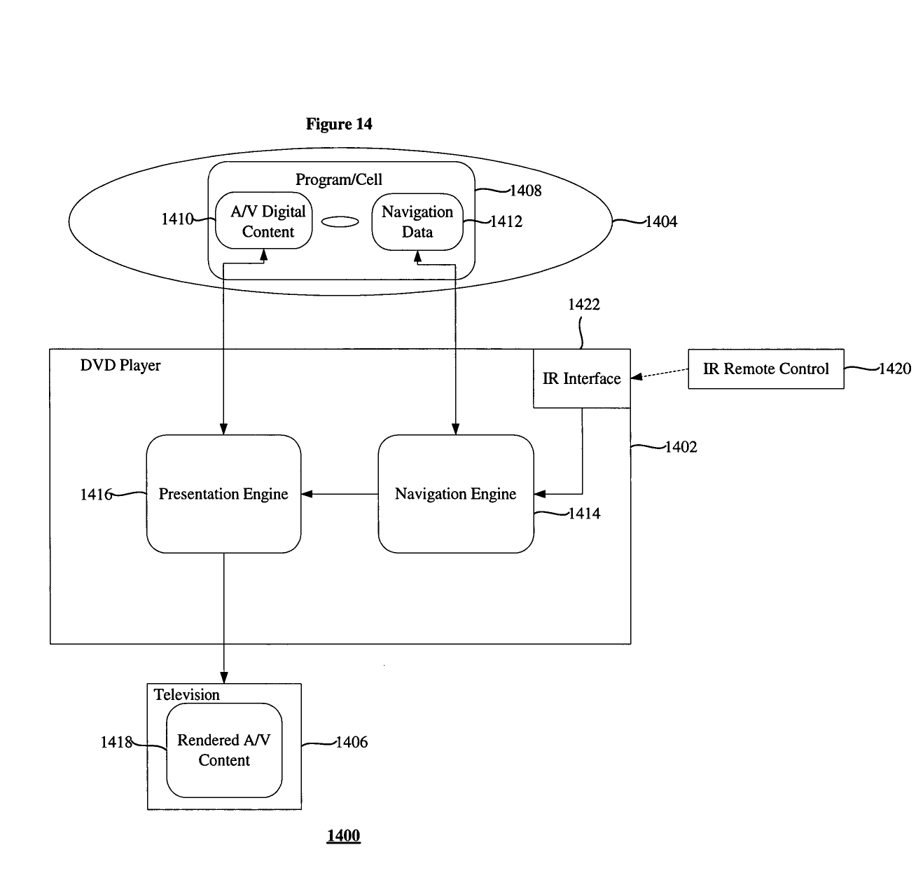

Step 1105 of FIG. 11 is illustrated in more detail in FIG. 13. FIG. 13 shows a preferred method for creating DVD-video compatible data structures by placing the AV assets 120 associated with each node 110 in the structure location assigned for that node and substituting links between the nodes with explicit references to destination locations. At step 1307 this results in an explicit DVD compatible data structure which may then be used to create a DVD disc image. Finally, the DVD disc image is used to record a DVD disc as a new audiovisual product.

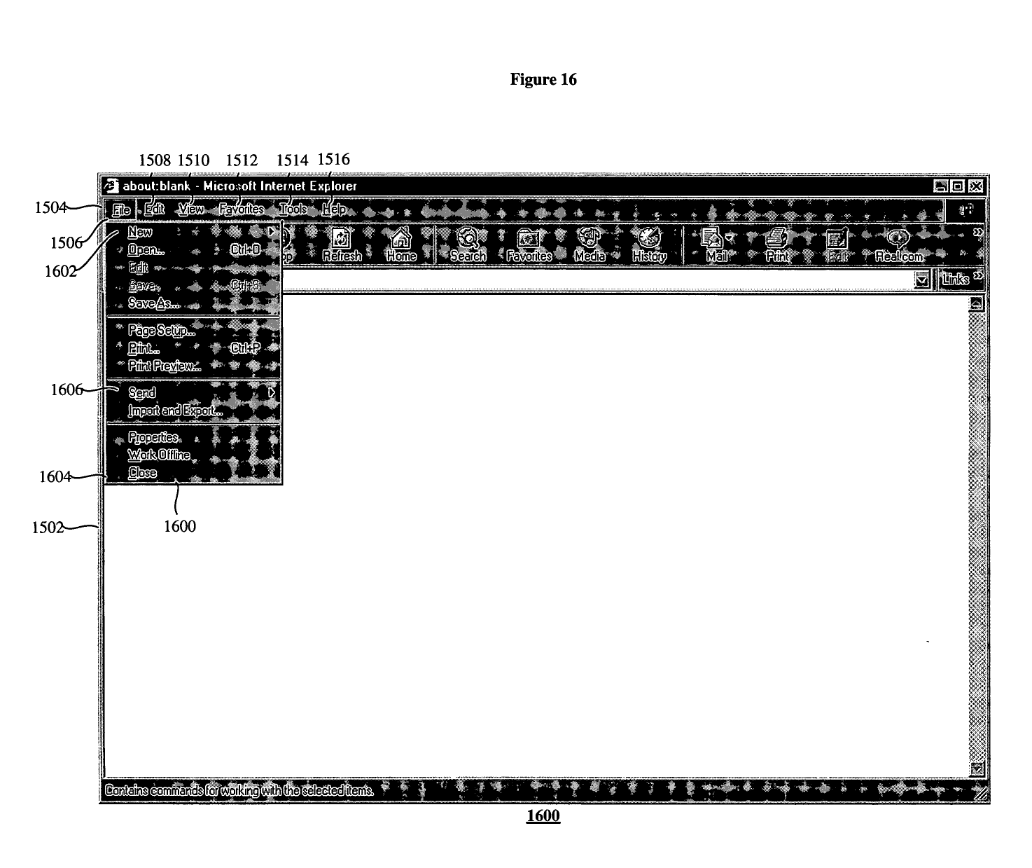

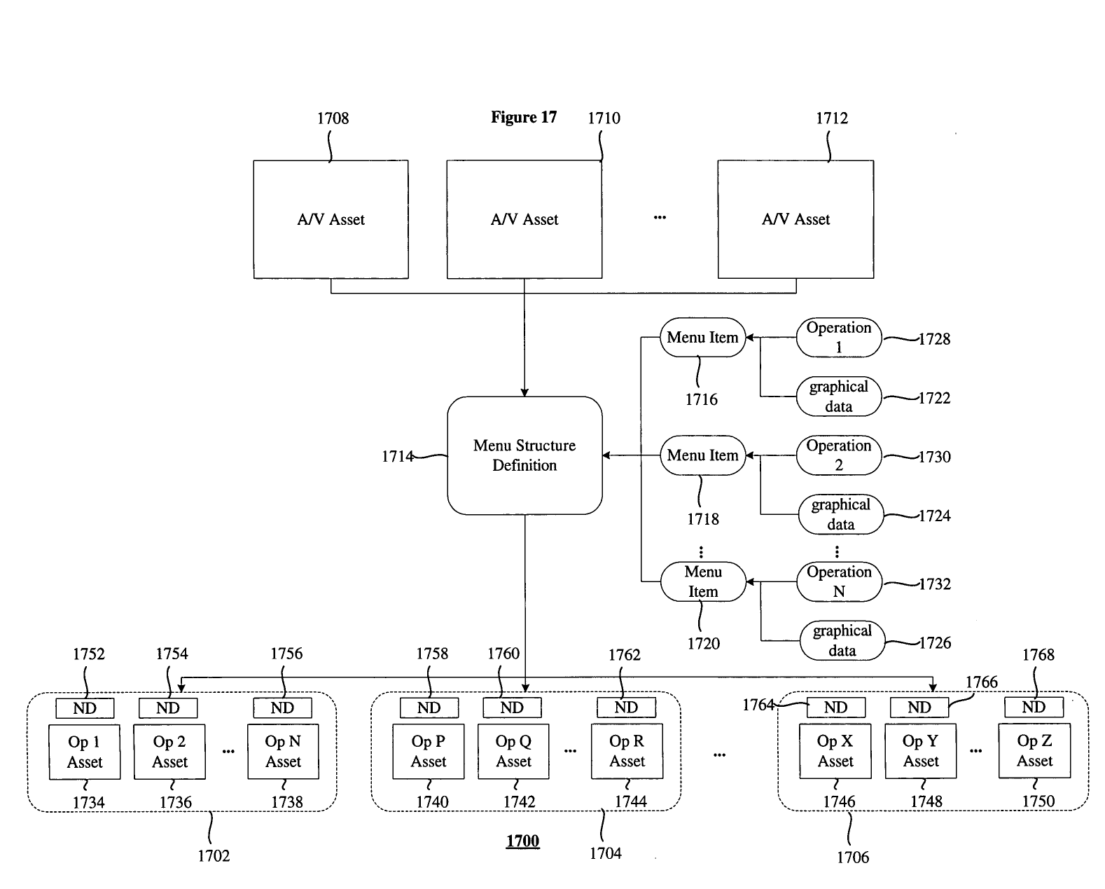

FIG. 17 shows an authoring process 1700 according to an embodiment of the present invention for automatically producing a number, M, of sets of assets 1702 to 1706 from corresponding assets 1708 to 1712 and a data structure 1714 defining a menu structure having a number, N, of menu items 1716 to 1720. The menu items, or only selected menu items, if appropriate, have associated data 1722 to 1726 representing a graphical manifestation or representation of the menu items. Also, the menu items, or only selected menu items, have associated data processing operations 1728 to 1732 that perform, or at least provide access to functions that can perform, data processing operations or manipulations upon the provided assets 1708 to 1712 to produce the sets of assets 1702 to 1706. It will be appreciated that the corresponding assets 1708 to 1712 represent a realisation of one or more raw content objects described above. Additionally, or alternatively, at least one of the graphical data 1722 to 1726 and the data processing operating 1728 to 1732 represent embodiments of raw content objects. These raw content objects are preferably represented graphically using respective icons, which, themselves, represent embodiments of the components described above.

In preferred embodiments, the user interface of the authoring tool that implements the authoring methods presents a component that represents a hierarchical menu system, called “Menu Component”. The menu component is parameterised with information that defines each of the items within the menus together with associated destinations, if appropriate, that it references to the functions or operations that are associated with the menu items. The menu component is expanded during the authoring process into nodes and links in which the nodes comprise respective start, end and intermediate representations of a corresponding menu to allow it to be, for example, progressively opened or closed.

It can be appreciated that the sets of assets 1702 to 1706 comprise respective assets. For example, the first set of assets 1702 comprises several visual assets 1734 to 1738 that were produced, from the first asset 1708, by applying appropriate or selected operations of the available operations 1728 to 1732 according to the menu structure, that is, according to whether a menu item is intended to be available for that first asset 1708. The assets 1734 to 1738 created are shown, for the purpose of a generalised description, as having been created from menu items that have operations A, B and C (not shown) associated with them. The operations A, B and C will be operations associated with corresponding menu items selected from the N illustrated menu items.

Similarly, the second set of assets 1704 comprises several assets 1740 to 1744 that were produced, from the second asset 1710, by applying appropriate or selected operations of the available operations 1728 to 1732 according to the menu structure, that is, according to whether a menu item is intended to be available for that second asset 1710. The assets 1740 to 1744 created are shown, for the purpose of a generalised description, as having been created from menu items that have operations P, Q and R (not shown) associated with them. The operations P, Q and R are associated with corresponding menu items selected from the N illustrated menu items. The same applies to the Mth set of assets 1706, which comprises respective assets 1746 to 1750 produced from the Mth asset 1712 and selected operations 1728 to 1732.

Navigational data 1752 to 1768 is also created for each asset 1734 to 1750. In one embodiment, the navigational data represents an embodiment of data contained within the expanded intermediate data structure of nodes and links. The navigational data is arranged to allow the navigation engine 1414 of the DVD player 1402 to obtain the next image or video sequence, that is, created asset, according to the menu structure. For example, if the first asset 1734 of the first set of assets 1702 represents an image, the navigational data associated with that first asset 1734 may comprise links to the second asset 1736, which might represent an image or video sequence showing that image together with the progressive display of a number of menu options associated with that image. For example, the menu options might relate to image processing techniques such as “posterising” the image. Therefore, in this example, the links associated with the second asset 1736 might comprise a link to a third asset (not shown) representing the image together with the progressive closing or contraction of the menu options previously displayed via the first asset 1734 and a link to a fourth asset showing a “posterised” version of the original image shown in the original asset 1708.

It will be appreciated that the assets might represent stills or video sequences. In preferred embodiments, the assets that relate to the menu options or menu items are video sequences that show the progressive expansion or contraction of the menus. Alternatively, or additionally, the assets might comprise two portions with a first portion representing a video sequence arranged to display or hide the dynamic menu and a second portion representing a still image or a further video sequence that is arranged to loop, that is, that is arranged to repeat once the menu has been displayed or hidden.

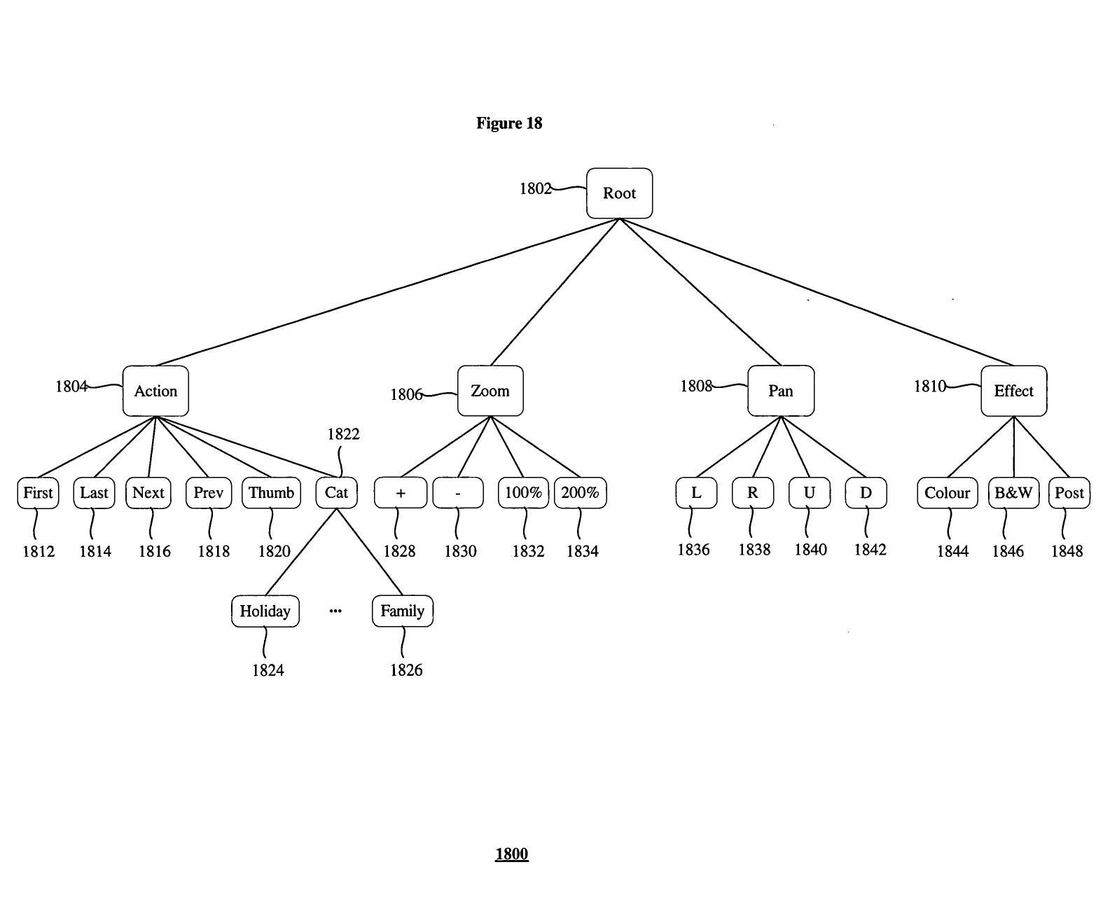

FIG. 18 illustrates graphically a possible menu structure definition in the form of a tree 1800. The data structure will be described with reference to a menu structure to perform image-processing techniques on a number of images. It will be appreciated that this is for the purpose of illustration only and that embodiments of the present invention are not limited thereto. The tree 1800 comprises a root node 1802 at which an asset might be displayed in its original or unadulterated form. Selecting “OK”, for example, using the remote control 1420, might be intended to cause a transition to a node for displaying the menu options available at that level in the menu structure. It can be appreciated from the example that invoking the “OK” button or the like is intended to produce a pull-down menu having four menu items 1804 to 1810. In the example, the four menu items are “Action” 1804, “Zoom” 1806, “Pan” 1808 and “Effect” 1810. At this stage in the menu structure, an originally displayed asset will be intended to also comprise a pull-down menu showing those options with those menu options having been progressively displayed via a corresponding video sequence. In order to select the menu options, sub-picture data is intended to be generated shown graphic overlays for each of the menu items “Actions” 1804, “Zoom” 1806, “Pan” 1808 and “Effect” 1810. It will be appreciated that the links between the nodes and leaves of the menu structure shown in FIG. 18 represent or could be represented by embodiments of the plurality of transitions described above.

It can be appreciated that the menu structure is defined such that selecting the first menu option 1804 produces a further menu comprising a number of sub-menu items. In the illustrated example, the sub-menu items are “First” 1812, “Last” 1814, “Next” 1816, “Previous” 1818, “Thumbs” 1820 and “Category” 1822. Again, the menu structure is arranged to have sub-picture graphic overlays associated with each of the options that can be used to select the options. Video assets are intended to be produced that give effect to operations associated with these options 1812 to 1822.

Selecting the “First” 1812 option is intended to display a first image of a number of images. Therefore, an asset displaying that first image is intended to be produced. Selecting the second option, “Last” 1814, is intended to display the last image of the number of images. Therefore, an asset for displaying that image will be produced using the last image. The “Previous” 1816 and “Next” 1818 menu items are intended to display previous and next images respectively. Suitably, video assets giving effect to the display of the previous and next images are intended to be created. The option “Thumbs” 1820 is intended to display thumbnail views of all, or selectable, images within a category or set of images. Again, selecting this option will necessitate producing a video asset that displays all of the thumbnail views or a selected number of those thumbnail views. It can be appreciated that any view of an asset might need associated navigation data to jump to the video asset or sequence showing the thumbnail views. The final option, “Category” 1822, is arranged to present a further sub-menu containing a number of categories of image; each represented by a corresponding menu item 1824 to 1826. Selecting one of these menu items is intended to display the first image in the category of images or a number of thumbnail views of the images within that category.

The menu structure might be defined such that the second menu item, “Zoom” 1806, produces a further menu having four zooming options; namely, “+” 1828, “−” 1830, “100%” 1832 and “200%” 1834, which, when selected, are intended to produce zoomed versions of an original asset. Suitably, giving effect to invocations of these menu items 1828 to 1834 will require corresponding video assets, firstly, to display the menu options and, secondly, to give effect to the transition from an initial, or starting, view of an asset to a zoomed view of the asset together with corresponding navigation data to allow the navigation engine 1414, in conjunction with the presentation engine 1416, to retrieve and render the video assets showing such zooming operations. Again, a sub-picture having appropriately positioned graphical overlays that are selectable and maskable will also be desirable.

The “Pan” 1808 menu option produces a further sub-menu comprising four menu items or options 1830 to 1842 that are arranged to allow a user to pan around an image. Accordingly, for each original asset, various video assets need to be defined that support such panning. Similarly, the final menu option, “Effect” 1810, is arranged to produce a further sub-menu comprising three menu items 1844 to 1848 that apply image processing techniques or effects to the original assets. The illustrated menu items are “Colour” 1844, “Black & White” 1846 and “Posterise” 1848, which require video assets to present the original assets in colour, in black and white and in a posterised forms respectively. Again, sub-picture image data would also be required to support selection of the menu items 1844 to 1848.

It will be appreciated that the assets produced, or intended to be produced, to give effect to traversing the menu structure and invoking menu items can be still images or video sequences representing a dynamic transition from one view of an asset to another view of an or the asset or representing a transition between views of an asset. It will be appreciated that such assets represent embodiments of members of the set of explicitly realised AV assets and the associated navigation data represent embodiments of the links associated with the expanded intermediate data structure.

It can be appreciated from the above that marshalling or producing the assets in preparation for creating a DVD that uses, or at least emulates, dynamic menus requires a very large number of assets to be created that anticipate all possible combinations of asset views according to the number of menus and menu options or items within those menus defined in the data structure. Furthermore, corresponding assets that show the expansion or contraction of the menu items either jointly or severally with respective asset data will also require a large number of assets to be generated.

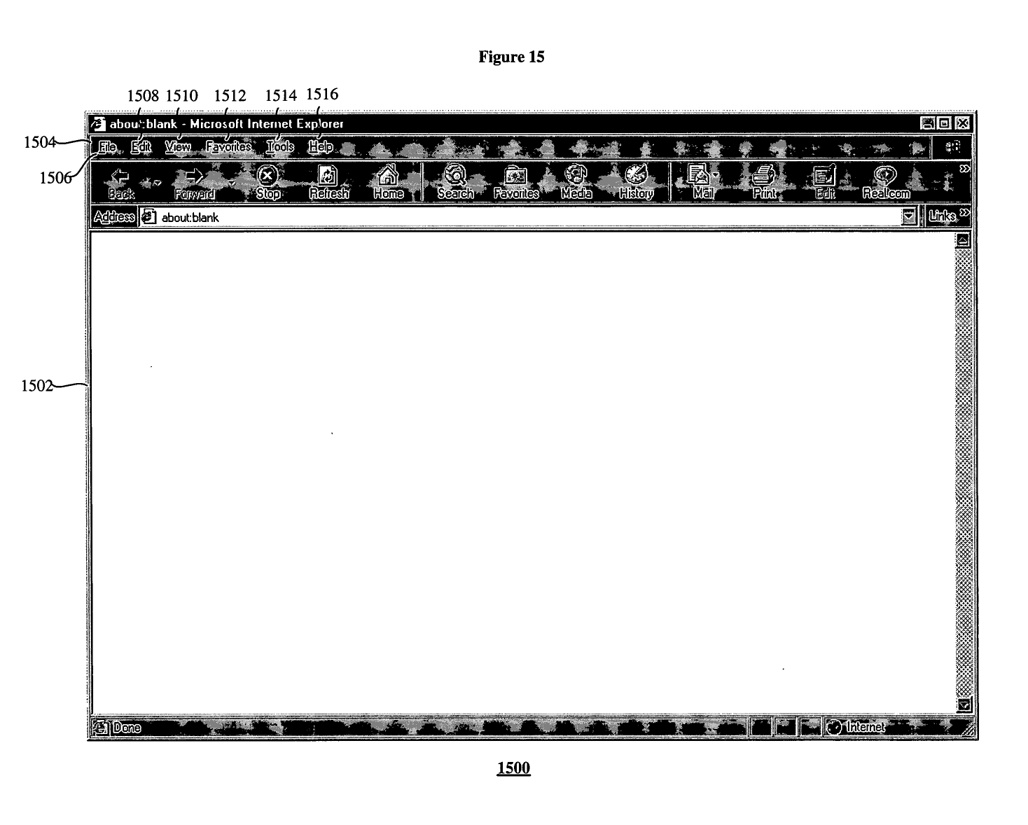

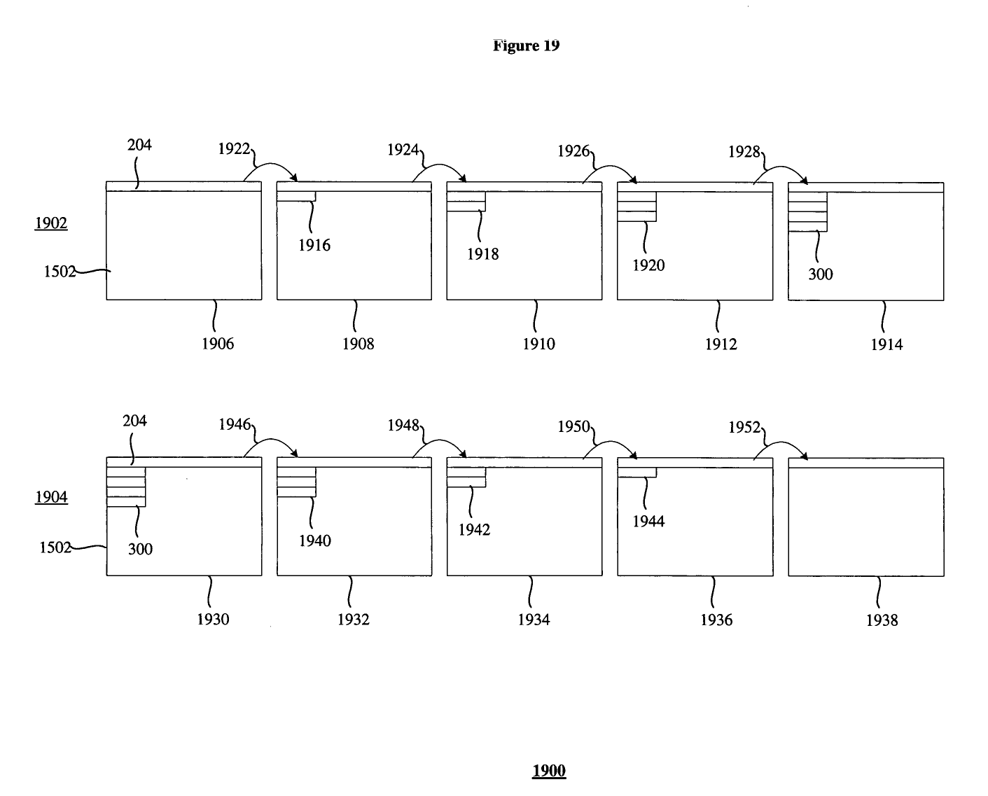

Referring to FIG. 19, there is shown schematically an authoring process 1900 for producing a pair of video sequences 1902 and 1904 comprising frames that illustrate the expansion and contraction of a pull-down menu, assuming that the menu structure and menu items are arranged to define a pull-down menu. The video sequences represent embodiments of elements of the sets of explicitly realised AV assets described above. The first video sequence 1902 has been shown, for illustrative purposes only, as comprising five frames 1906 to 1914. The first frame 1906 is a schematic representation of the image shown in FIG. 15. In the interests of clarity, only the menu bar 1504 and window 1502 of the image of FIG. 15 have been illustrated in each frame. The second frame 1908 is shown with a portion 1916 of the pull-down menu 1600 having been displayed. It can be seen that the third and fourth frames 1910 and 1912 respectively illustrate progressively larger portions 1918 and 1920 of the pull-down menu 1600. The final frame 1914 illustrates the complete pull-down menu 1600 and corresponds to the image shown in FIG. 16. The progressively increasing or expanding portions 1916 to 1920 of the pull-down menu 1600 are illustrated as expanding on a per menu item basis, that is, each portion contains a greater number of menu items as compared to a previous portion. Again, for the purpose of clarity of illustration only, the pull-down menu 1600 has been shown as comprising four menu items rather than the full 13 menu items shown in FIG. 16. However, it will be appreciated that a pull-down menu, according to requirements, may present any predetermined number of menu items. The progressive expansion and contraction of the menus corresponds to or emulates revealing or hiding of menus within a Windows context.

Although FIG. 19 illustrates the creation of individual frames, it will be appreciated that in preferred embodiments the visual assets 1906 to 1914 will take the form of a number of frames, that is, video sequences. For example, visual asset 1906 will, in practice, represent a video sequence comprising a number of frames that progressively displays the first portion 1916 of the menu over a predetermined period of time. It will be appreciated that the number of frames constituting such a video sequence might be a function of the desired display speed for the menu.

Navigation data 1922 to 1928 provides links between video assets and allows the navigation engine to retrieve the first video sequence or set of video assets or sequences 1902 from the DVD 1404 and to cause the presentation engine 1416 to display the first video sequence using that retrieved data. The navigation data 1922 to 1928 represents a realisation of the links of the expanded intermediate data structure of nodes and links.

The second video sequence 1904 of FIG. 19 has also been shown, for illustrative purposes only, as comprising five frames 1930 to 1938. The first frame 1930 is a schematic representation of the image shown in FIG. 16, in which the pull-down menu 1600 is in its fully expanded form. The second frame 1932 is shown with a smaller portion 1940 of the pull-down menu 1600 having been displayed. It can be seen that the third and fourth frames 1934 and 1936 respectively display progressively smaller portions 1942 and 1944 of the pull-down menu 1600. The final frame 1938 illustrates the complete pull-down menu 1600 in its most contracted form and corresponds to the image 1500 shown in FIG. 15. The progressively decreasing or contracting portions 1940 to 1944 of the pull-down menu 1600 are illustrated, again, as contracting on a per menu item basis, that is, each portion contains progressively fewer menu items as compared to a previous portion. Navigation data 1946 to 1952 linking each video asset will also be created to allow the navigation engine 1414 to retrieve the asset and cause the presentation engine 1416 to display that video asset. Again, it will be appreciated that each video asset 1930 to 1938 will, in practice, represent a video sequence and that the embodiment described above has been illustrated using frames rather than sequences for the purposes of clarity of illustration only.

It will be appreciated the video content panes of the video sequences 1902 and 1904 have been shown “empty” for the purposes of clarity only. In practice, the content panes will contain content such as, for example, image data or video sequence data.

It will be appreciated that although the pull-down menu has been described with reference to expanding and contracting on a per menu item basis, embodiments can be realised in which any predetermined expansion or contraction step size is used. It will be appreciated that smaller or greater steps sizes might affect the number of frames that are required to form the first 1902 and second 1904 video sequences or the smoothness of the display of the pull-down menu 1600. It can be appreciated that rendering such pre-authored video sequences as the first 1902 and second 1904 video sequences enables pull-down menus to be provided, or at least emulated, using DVD players, which increases the richness of the user interfaces for, and the user experience, of DVDs.

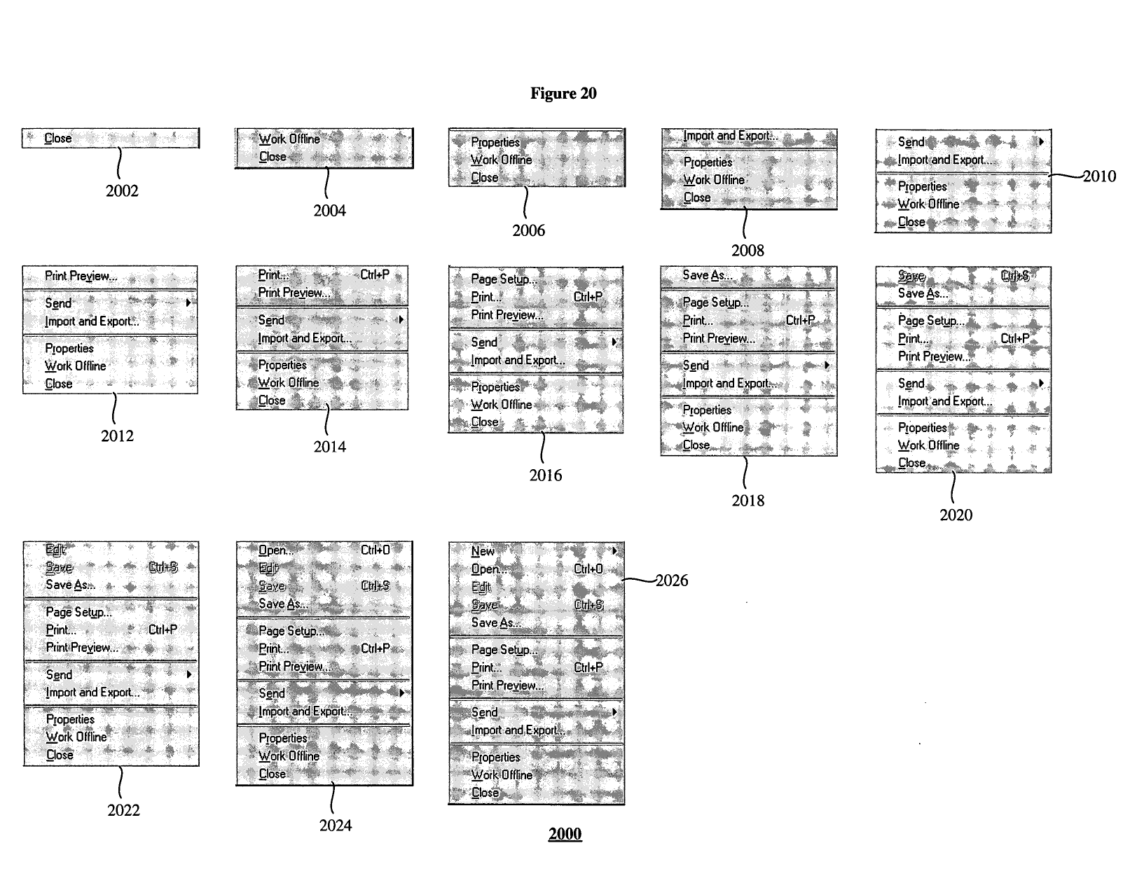

FIG. 20 shows, schematically, the graphical data 2000 that can be used to produce a progressively expanding or contracting pull-down menu 1600 according to an embodiment. It can be seen that the data 2000 comprises 13 pull-down menu portions 2002 to 2026. These portions 2002 to 2026 are used to produce the video sequences 1902 and 1904 described above with respect to FIG. 19. A complete frame of video may comprise both the pull-down menu portions or complete menu with or without the “application” window, such as that displayed in FIG. 15, together with other data or information such as, for example, content for the application window and/or a background on which the application window sits, if it does not occupy the whole of the 720×480 or 720×576 pixels of the DVD NTSC and the DVD PAL/SECAM pixel resolutions, respectively. The pull-down menu portions 2002 to 2026 represent embodiments of raw content that are represented as raw content objects within the authoring method.

The data representing the video sequences 1902 and 1904, stored on the DVD 1404, will also be accompanied by sub-picture data, carried by at least one of the thirty-two available sub-picture streams. The sub-picture data is used to produce graphical overlays or highlights for selected menu items of the various menu items of the pull-down menu. The sub-picture data is used to produce a bitmap image bearing graphical overlays that are displayed on top of, or otherwise combined with, corresponding video sequences. The manner and position of display of the graphical elements are controlled or determined using corresponding sub-picture buttons with associated highlights that are selectively operated as masks to hide or reveal an associated graphical overlay. The sub-picture data represents an embodiment of raw content of the raw content objects described above and the bitmap images or graphical overlays represent embodiments of elements of the set of explicitly realised AV assets.

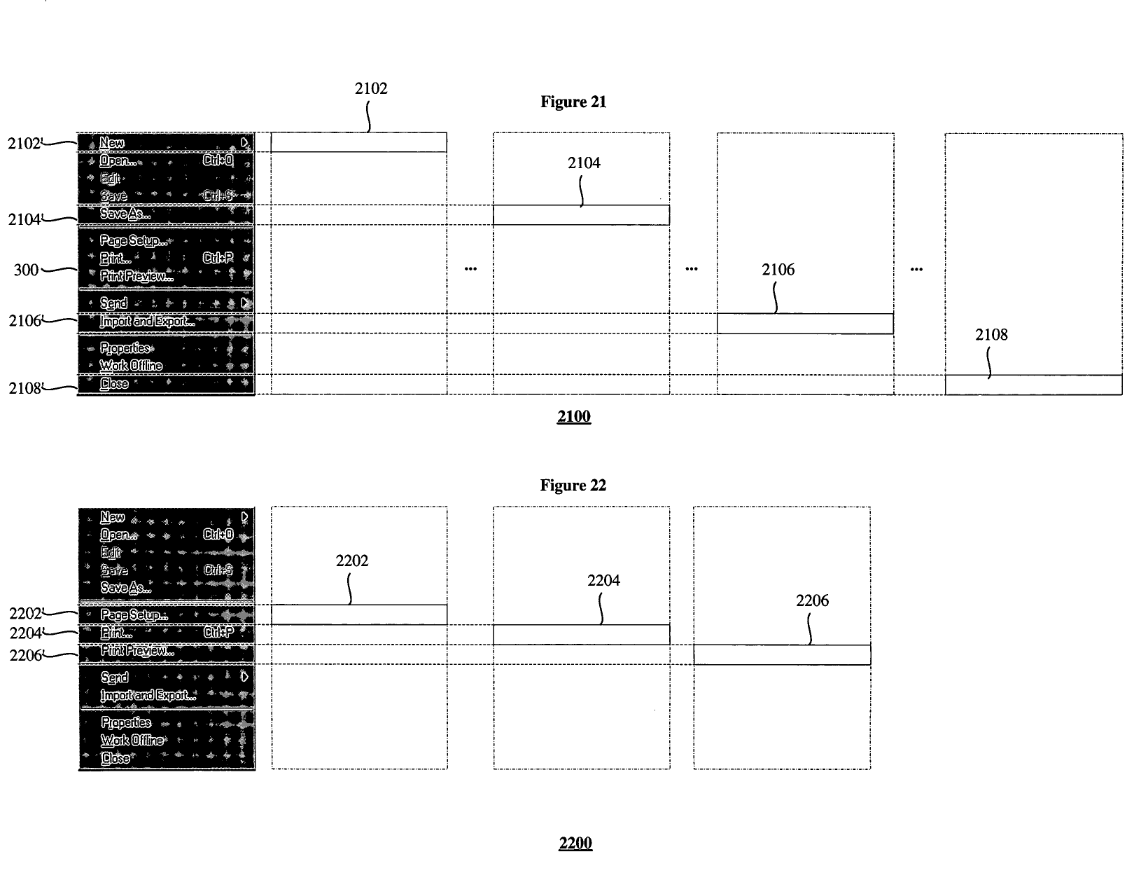

Referring to FIG. 21, there is shown schematically the relationship 2100 between a selected number of graphical overlays 2102 to 2108 and corresponding portions 2102′ to 2108′ of the pull-down menu 1600. The sub-picture buttons or masks associated with each graphical overlay 2102 to 2108 are arranged such that, when invoked in conjunction with the video sequence displaying the pull-down menu, the sub-picture bitmaps selectively highlight or overlay the corresponding portions 2102′ to 2108′ of the pull-down menu 1600. The presentation engine 1416, under the control of the navigation engine 1414, displays the appropriate sub-picture graphical overlay 2102 to 2108 in response to user commands received from the remote control 1420 using the sub-picture buttons or masks. For example, FIG. 22 illustrates the relationship 2200 between three central graphical overlays 2102 to 2106 of a sub-picture (not shown) and their corresponding menu items 2102′ to 2106′. Assume that the central graphical overlay 2104 is currently displayed. The navigation engine 1414, in response to an “up” or “down” user command received from the IR control 1420, will cause the presentation engine 1416 to display a selected overlay 2102 or 2106 to highlight the “Page Setup” 2102′ or “Print Preview” 2106′ menu items respectively by masking the appropriate overlays that are not required to be displayed.

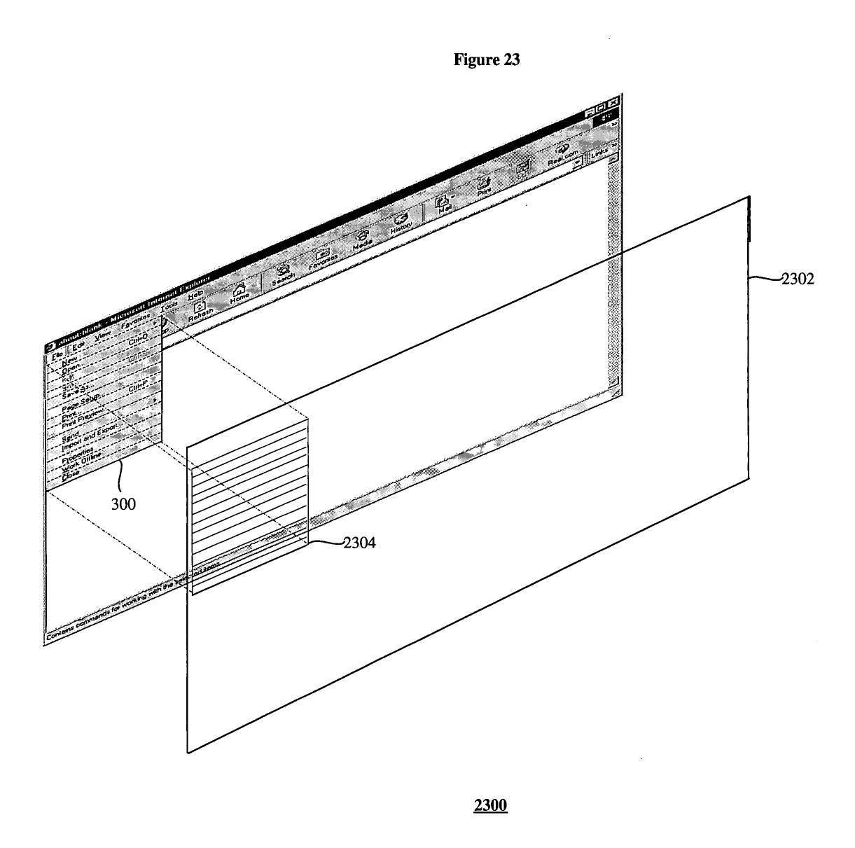

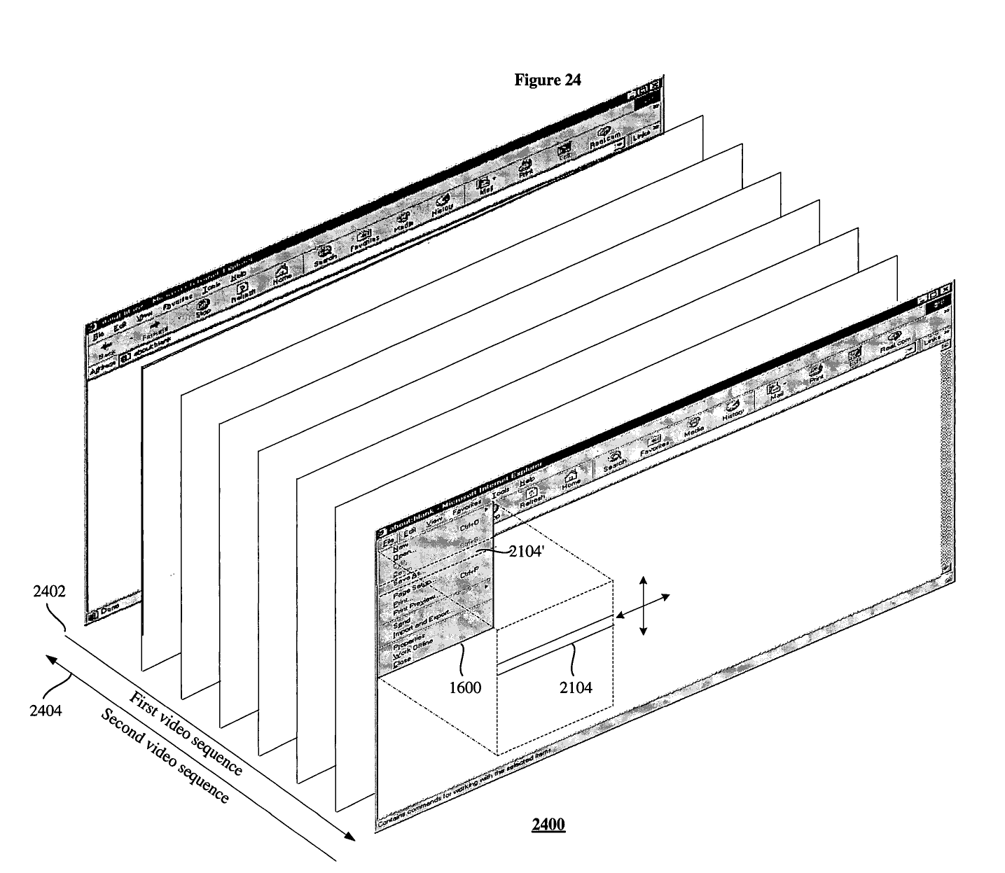

Referring to FIG. 23, there is shown the relationship 2300 between a sub-picture 2302 containing graphical overlays 2304 and a video sequence or frame containing the pull-down menu 1600 in its fully expanded state. The sub-picture is notionally divided into a number of regions (not shown) known as buttons that can be selectively displayed in response to user actions, that is, commands received from the IR control 1420. These buttons are used to reveal or hide a number of highlight regions that are aligned with respective menu options of the pull-down menu 1600. FIG. 24 illustrates the process 2400 of successive display of the frames constituting the first and second video sequences, according to the direction of the time lines 2402 and 2404. The relationship between the sub-picture graphical overlay 2104 and the corresponding “Save As” menu item 2104′ of the pull-down menu 1600 can be more easily appreciated.

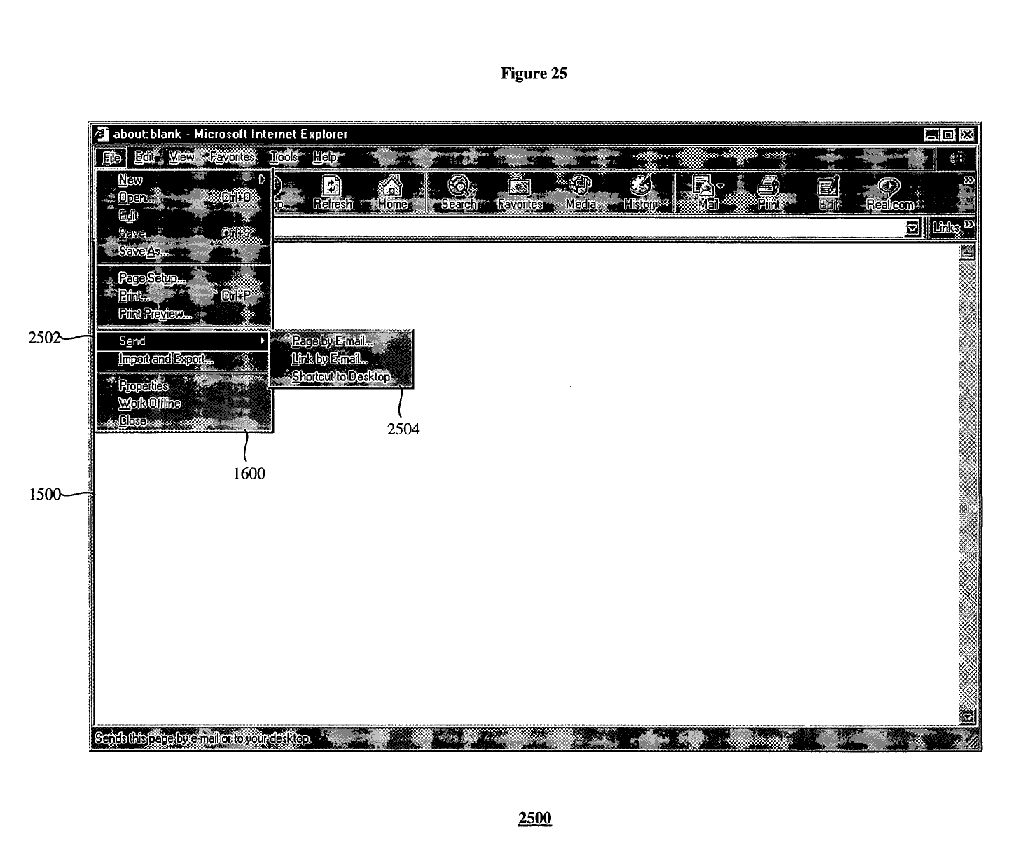

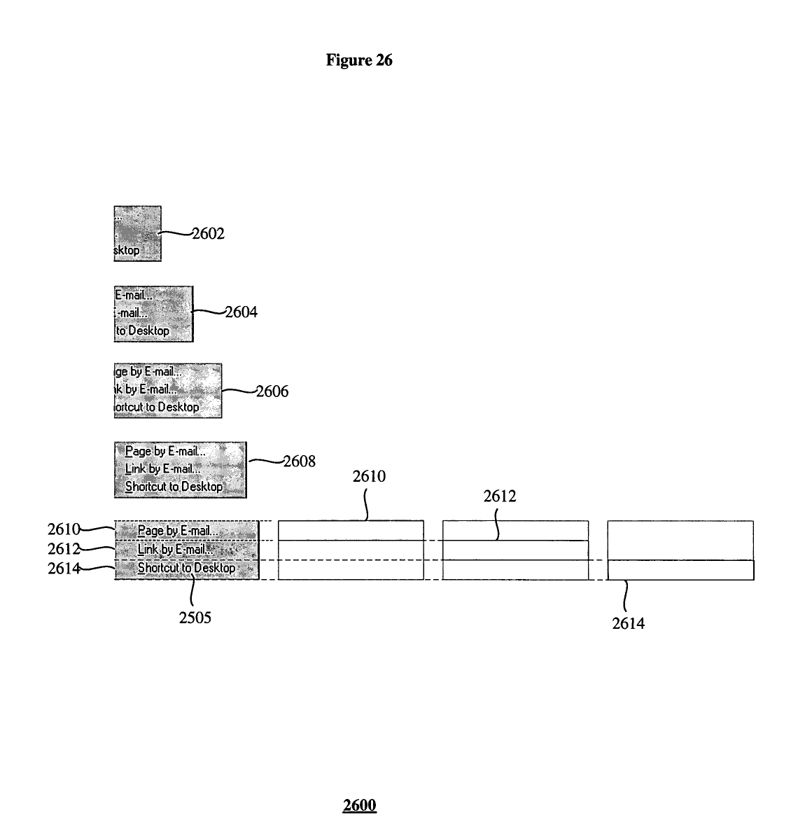

FIG. 25 illustrates a view 2500 of the application 1500 with one menu item 2502 of the pull-down menu 1600 having been invoked. It can be appreciated that this invocation has produced a further menu 2504. In preferred embodiments, the further menu 2504 is progressively displayed in a left-to-right manner in a similar process to the progressive display of the pull-down menu 1600 itself. The authoring process to produce the data used in producing a video sequence having such a left-to-right menu needs to produce data 1300 such as, for example, that shown in FIG. 26. The left-to-right menu data 1300 comprises a number of portions 2602 to 2608 of the further menu 2504. Each portion 2602 to 2608 is progressively bigger or smaller than a succeeding or preceding portion respectively. Also shown, in a manner analogous to that of FIG. 21, are the sub-picture graphical overlays 2610 to 2614 that correspond to the respective menu items 2610′ to 2614′ of the further menu 2204. The data shown in FIG. 26 is used to produce video sequences for progressively expanding or contracting the further menu 1204 in a manner that is substantially similar to the process used to produce the first 1902 and second 1904 video sequences shown in FIG. 19.

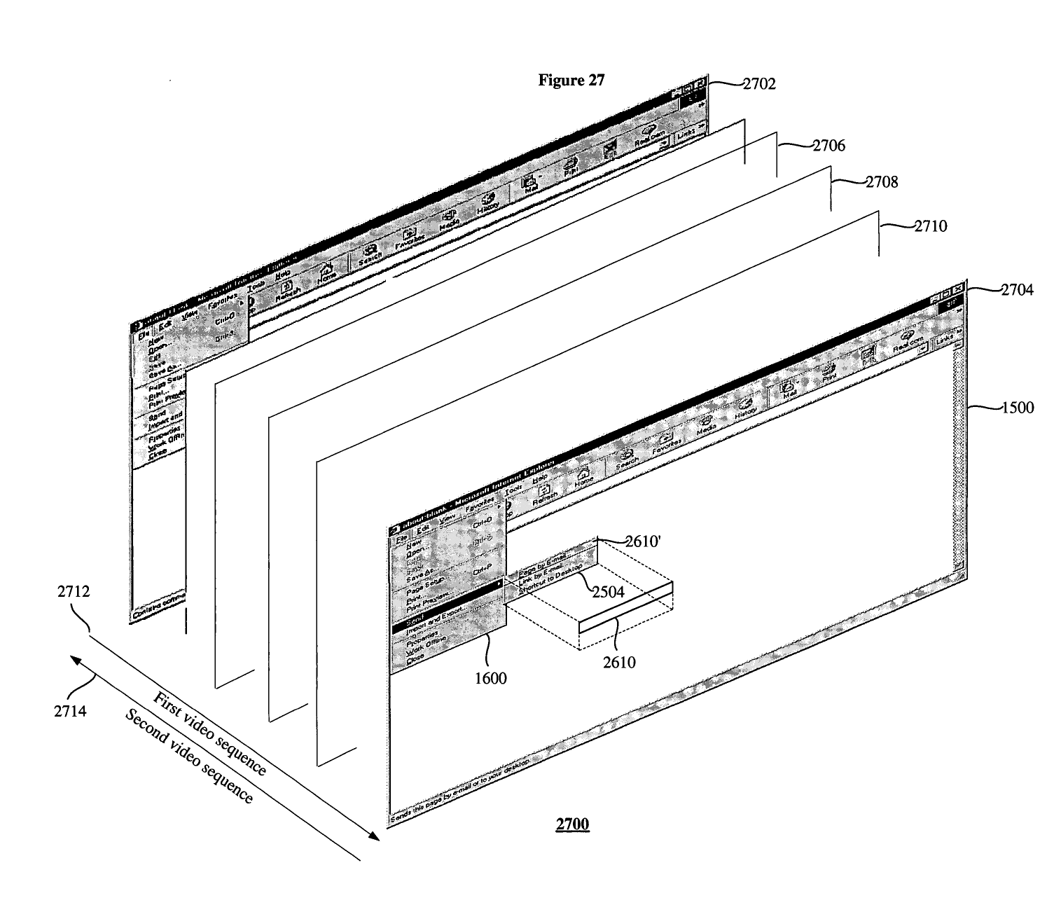

FIG. 27 illustrates, with greater clarity, the relationship 2700 between the further menu 2504 and the sub-picture graphical overlay 2610 for the “Page by E-mail” 2610′ menu item. It can be appreciated that the pull-down menu 1600 has been invoked, followed by the selection of the “Send” menu item 2502, which has caused the display of the left-to-right menu 2504 and the corresponding sub-picture graphical overlay 2610. Again, the start frame 2702 and end frame 2704 are shown, together with intermediate frames 2706 to 2710, as constituting expansion and contraction video sequences according to the direction of the time lines 2712 and 2714 respectively.

It will be appreciated that the navigation data associated with the first video sequence 1902 will include a link to the video sequence for expanding the further menu 2504 to give effect to that expansion should the “Send” menu item 2502 be invoked. Such navigation data is an example of data of the expanded intermediate data structure.

It will be appreciated from the above that the process of marshalling or producing a visual asset for displaying and using dynamic menus involves producing video sequences for both the expansion and contraction, that is, the display and hiding, of the pull-down menu together with navigation data linking the frames and/or video sequences, according to planned or predetermined user operations and sub-picture graphical overlay data and navigation data for controlling the display of the sub-picture graphical overlays. It will be appreciated that such video sequences represent embodiments of the AV assets described above. Also, the navigation data represents embodiments of the links of the expanded intermediate data structure.

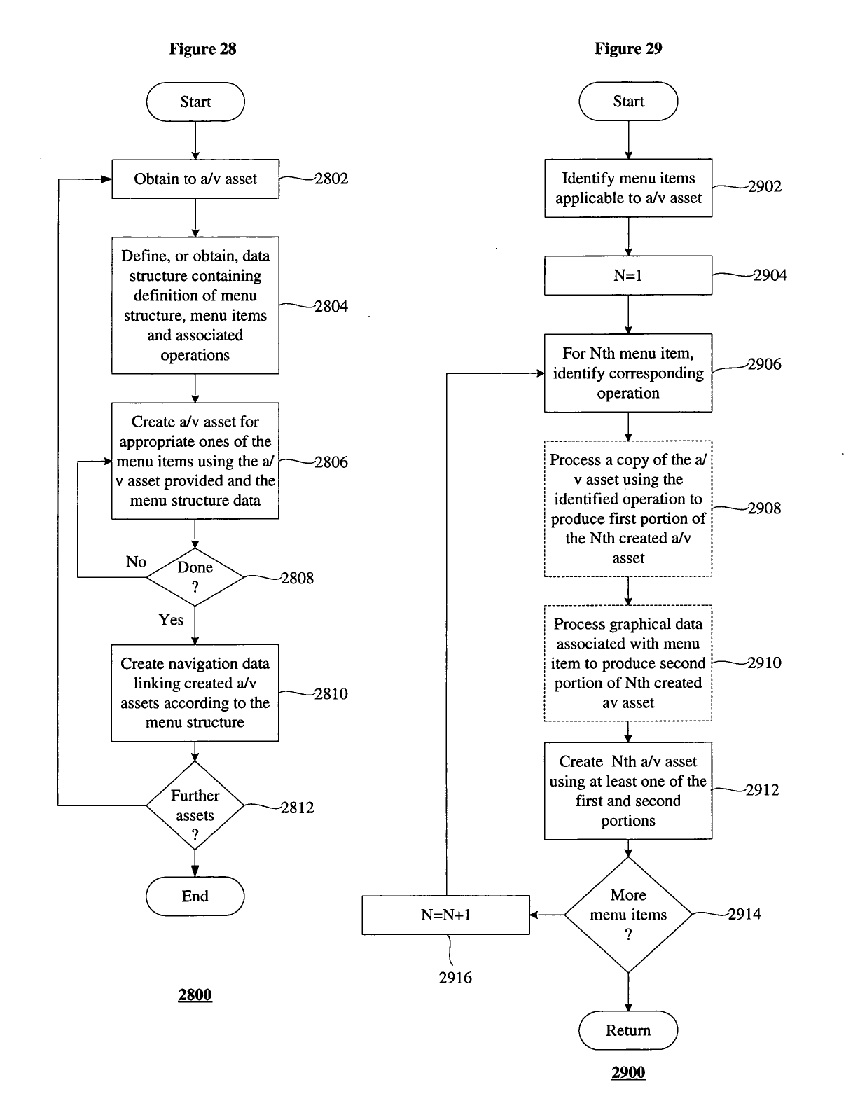

Referring to FIG. 28 there is shown a flowchart 2800 for producing visual assets according to an embodiment of the present invention. At step 2802, an original visual asset is provided or obtained. The original visual asset is an embodiment of raw content, that is, a raw content object that is represented by a respective component of the plurality of components described above. A data structure comprising a definition of a menu structure together with associated menus and menu items and operations related to those menu items is defined at step 2804. The data structure represents a manifestation of the plurality of transitions that represent movement between appropriate components of the plurality of components Such a data structure has been described above in relation to FIGS. 17 and 18. An asset is created, at step 2806 using appropriate menu items and their related operations as well as the originally provided video asset. The created assets represent a realisation of a member of the set of explicitly realised AV assets. It is determined at step 2808 whether or not all assets relating to the originally provided asset have been created. If the determination at step 2808 is negative, processing returns to step 2806 where a further asset is created, again, according to the needs or requirements defined by the menu structure defined in step 2804.

Having created the video assets from an original asset, navigation data linking the assets according to an intended navigational strategy, which is, again, defined by the menu structure, is created at step 2810. The navigation data represents an embodiment of links between the created video assets that form part of the expanded intermediate data structure. Furthermore, the intended navigation strategy is reflected in the plurality of transitions that represent movement between the plurality of components. A test, performed at step 2812, determines whether or not there are further a/v assets to process. If the test is positive, processing continues at step 2802, where the next asset to be processed is obtained. If the test is negative, processing terminates.

FIG. 29 shows a flowchart 2900 that illustrates the steps undertaken in steps 2906 and 2908 of FIG. 28 in greater detail. The menu items applicable to a provided video asset are identified and counted at step 2902. The menu items and the video asset are embodiments of raw content that are represented as respective components. A count, N, is set to 1 at step 2904. For the Nth menu item, the corresponding operation such as, for example, the operations 1728 to 1732 shown in FIG. 17, are identified. In an embodiment, the data or function representing the menu operation can be represented by a respective component of the plurality of components described above. At step 2908 a copy of the originally provided video asset is processed using the appropriate operation identified at step 2906 to create at least a portion, or a first portion, of an intended Nth video asset.

At step 2910, the graphical data associated with the Nth menu item is processed to produce a second portion of the Nth video asset. The graphical data represents an embodiment of raw content that is depicted as one of the plurality of components. The complete or whole of the Nth video asset is created using at least one of the first and second portions at step 2912. The complete or whole of the Nth video asset represent a realisation of an element of the set of explicitly realised AV assets. It is determined, at step 2914, whether there are more menu items to be processed for which corresponding video assets, derived from the originally provided video asset, are required. If the determination is positive, processing continues to step 2916 where N is incremented and control passes to step 2906, where the next menu item is considered. If the determination at step 2914 is negative, processing terminates or, more accurately, processing returns to step 2808 of FIG. 28. It will be appreciated by those skilled in the art that the menu structure defined in the data structure might comprise sub-menus. Therefore, the process of producing the assets for such a complex menu structure might require nested or recursive applications of the steps shown in the flowcharts.

Although the above embodiments have been described within the context of a DVD equivalent of Internet Explorer, embodiments of the present invention are not limited thereto. Embodiments can be realised in which the pull-down menus are implemented in any context. For example, the “application” might be intended to step through an album of photographs or video sequences and the menu items might control the display of those photographs or video sequences. Still further, it will also be appreciated that the pull-down menu stems from a corresponding menu bar item. However, the pull-down menu can be arranged to appear, at a predetermined screen position, in response to a user-generated event.

The above embodiments have been described with reference to creating video or visual assets. However, embodiments of the present invention are not limited to such an arrangement. Embodiments can be realised in which the assets processed and/or produced are audio-visual assets.

Although the above embodiments have been described in the context of dynamic menus, embodiments of the present invention are not limited to such an arrangement. Embodiments can be realised in which, for example, modal or modeless dialogue boxes, or other GUI elements, are emulated via correspond video sequences.

It will be appreciated that the video assets created in the above embodiments might use an image processing system or multimedia authoring system by which an author can create the assets. For example, to overlay menu image data on top of image or video data one skilled in the art might use Macromedia Flash, Macromedia Director or Adobe AfterEffects.

Furthermore, it will be appreciated that the embodiments of the present invention are preferably implemented, where appropriate, using software. The software can be stored on or in various media such as, for example, magnetic or optical discs or in ROMs, PROMs and the like.

For the avoidance of doubt, the phrase “one or more” followed by, for example, a noun comprises “one [noun]” and “two or more [nouns]”, that is, it comprises “at least one [noun]”and visa versa. Therefore, the phrase “one or more video sequences” comprises one video sequence and, similarly, the phrase “one or more original assets” comprises one original asset as well as both extending to “a plurality of video sequences” and “a plurality of original assets” respectively.

The DVD authoring method and apparatus described above have a number of advantages. Creating components that represent parameterised sections of audio visual content allow many individual AV assets to be implicitly defined and then automatically created. Repetitive manual tasks are avoided, which were previously time consuming, expensive and error-prone. The authoring method and apparatus significantly enhance the range of features available in existing categories of audiovisual products or content such as movie presentations. They also allow new categories of audiovisual products or content to be produced. These new categories include both entertainment products or content such as quiz-based games and puzzle-based games, as well as information products such as catalogues, directories, reference guides, dictionaries and encyclopaedias. In each case, the authoring method and apparatus described herein allow full use of the video and audio capabilities of DVD specifications such as DVD-video. A user may achieve playback using a standard DVD player with ordinary controls such as a remote control device. A DVD-video product having highly complex navigational content is readily created in a manner which is simple, efficient, cost effective and reliable.

Although a few preferred embodiments have been shown and described, it will be appreciated by those skilled in the art that various changes and modifications might be made without departing from the scope of the invention, as defined in the appended claims.

The audiovisual product comprises at least any of data representing audiovisual content or from which such content can be derived, DVD video disc image data, other data compliant with the DVD specification or a medium storing such data.

Although the above embodiments have been described with reference to the product or content being playable by a “standard DVD player”, it will be appreciated that other players can equally well be accommodated such as, for example, software players, set-top boxes or other means of processing or otherwise rendering audiovisual content using hardware or software or a combination of hardware and software.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings) and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. An authoring method for use in creating an audiovisual product or content, comprising the steps of:
defining a plurality of components, the components implicitly representing functional sections of audiovisual content with respect to one or more raw content objects, and a plurality of transitions that represent movements between the plurality of components;
expanding the plurality of components and the plurality of transitions to provide a set of explicitly realised AV assets and an expanded intermediate data structure of nodes and links, where each node is associated with an AV asset of the set and the links represent movement from one node to another; and
creating an audiovisual product or content in a predetermined output format, using the AV assets and the expanded intermediate data structure of the nodes and the links, wherein the audiovisual product comprises data representing a menu.

2. The method of claim 1, wherein the defining step comprises defining at least one information component that comprises a reference to a raw content object.

3. The method of claim 2, wherein the reference denotes a file path to a location where the raw content object is stored.

4. The method of claim 1, wherein the defining step comprises defining at least one choice component comprising a reference to at least one raw content object, and at least one authoring parameter.

5. The method of claim 4, wherein the at least one authoring parameter is adapted to control a selection or modification of the at least one raw content object.

6. The method of claim 4, wherein the at least one authoring parameter comprises a runtime variable available during playback of the audiovisual product.

7. The method of claim 4, wherein the at least one authoring parameter comprises an authoring-only parameter that will not be available during playback of the audiovisual product.

8. The method of claim 4, wherein the choice component comprises a reference to a presentation template and a reference to at least one substitutable raw content object to be placed in the template according to the at least one authoring parameter.

9. The method of claim 1, wherein the defining step comprises defining at least one meta-component representing a set of components and transitions.

10. The method of claim 9, wherein the at least one meta-component is a procedurally defined representation of the set of components and transitions.

11. The method of claim 1, wherein each transition represents a permissible movement from one component to another component.

12. The method of claim 1, wherein each transition is associated with a triggering event.

13. The method of claim 12, wherein the triggering event is an event occurring during playback of the audiovisual product.

14. The method of claim 13, wherein the triggering event is receiving a user command, or expiry of a timer.

15. The method of claim 1, further comprising the step of checking expected conformance of the audiovisual product with the predetermined output format, using the plurality of components and the plurality of transitions.

16. The method of claim 15, wherein the predetermined output format is a hierarchical data structure having limitations on a number of objects that may exist in the data structure at each level of the hierarchy, and the checking step comprises predicting an expected number of objects at a level and comparing the expected number with the limitations of the hierarchical data structure.

17. The method of claim 15, wherein the checking step comprises predicting an expected total size of the audiovisual product, and comparing the expected total size against a storage capacity of a predetermined storage medium.

18. The method of of claim 1, wherein the expanding step comprises, for each component, building one or more of the set of explicitly realised AV assets by reading and manipulating the one or more raw content objects.

19. The method of claim 18, wherein:
the defining step comprises defining at least one choice component comprising a reference to a plurality of raw content objects and at least one authoring parameter; and
the building step comprises:
selecting one or more raw content objects from amongst the plurality of raw content objects using the at least one authoring parameter; and
combining the selected raw content objects to form one of the AV assets.

20. The method of claim 19, comprising repeating the selecting and combining steps to automatically build a plurality of the explicitly realised AV assets from the one of the components.

21. The method of claim 1, wherein the expanding step comprises:
creating from each one of the plurality of components one or more explicitly realised AV assets to provide the set of AV assets;
creating the expanded intermediate data structure wherein each node represents one AV asset of the set; and
creating a set of links between the nodes.

22. The method of claim 21, wherein each transition is associated between first and second components, and creating the set of links comprises evaluating each transition to create one or more links, each of the links being between a node created from the first component and a node created from the second component.

23. The method of claim 1, wherein the expanding step comprises evaluating at least one of the transitions to create exit logic associated with at least one first node, evaluating one of the components to create entry logic associated with at least one second node, and providing a link between the first and second nodes according to the entry logic and the exit logic.

24. The method of claim 23, wherein at least one of the transitions is associated with a triggering event, and the expanding step comprises evaluating the triggering event to determine the exit logic associated with the at least first one node.

25. The method of claim 1, further comprising the step of checking expected conformance of the audiovisual product with the predetermined output format, using the AV assets and the expanded intermediate data structure of nodes and links.

26. The method of claim 25, wherein the predetermined output format is a hierarchical data structure having limitations on a number of objects that may exist in the data structure at each level of the hierarchy, and the checking step comprises predicting an expected number of objects at a level and comparing the expected number with the limitations of the hierarchical data structure.

27. The method of claim 26, wherein the checking step comprises predicting an expected total size of the audiovisual product, and comparing the expected total size against a storage capacity of a predetermined storage medium.

28. The method of claim 1, wherein the AV assets have a data format specified according to the predetermined output format.

29. The method of claim 1, wherein the AV assets each have a data format according to the predetermined output format, whilst the raw content objects are not limited to a data format of the predetermined output format.

30. The method of claim 1, wherein the predetermined output format is a DVD-video specification.

31. The method of claim 30, wherein the AV assets each comprise a video object, zero or more audio objects, and zero or more sub-picture objects.

32. The method of claim 30, wherein the AV assets each comprise at least one video object, zero to eight audio objects, and zero to thirty-two sub-picture objects, according to the DVD-video specification.

33. The method of claim 1, wherein the creating step comprises creating objects in a hierarchical data structure defined by the predetermined output format with objects at levels of the data structure, according to the intermediate data structure of nodes and links, and where the objects in the hierarchical data structure include objects derived from the explicitly realised AV assets.

34. The method of claim 33, wherein the predetermined output format is a DVD-video specification and the creating step comprises creating DVD-video structure locations from the nodes of the expanded intermediate data structure, placing the explicitly realised AV assets at the created structure locations, and substituting the links of the expanded intermediate data structure with explicit references to the DVD-video structure locations.

35. An authoring method for use in creating a DVD-video product, comprising the steps of:
creating a plurality of components representing parameterised sections of audiovisual content, and a plurality of transitions representing movements between components;
expanding the plurality of components and the plurality of transitions to provide a set of AV assets and an expanded data structure of nodes and links, where each node is associated with an AV asset of the set and the links represent movement from one node to another; and
creating a DVD-video format data structure from the AV assets, using the nodes and links, wherein the DVD-video format data structure comprises data representing, or at least emulating, menu data.

36. The method of claim 35, comprising creating at least one information component comprising a reference to an item of AV content.

37. The method of claim 35, comprising creating at least one choice component comprising a reference to at least one item of AV content, and at least one parameter for modifying the item of AV content.

38. The method of claim 37, wherein the choice component comprises a reference to a presentation template and a reference to at least one item of substitutable content to be placed in the template according to the at least one parameter.

39. The method of claim 37, wherein the choice component comprises at least one runtime variable available during playback of an audiovisual product in a DVD player, and at least one authoring parameter not available during playback.

40. The method of claim 35, comprising creating at least one meta-component representing a set of components and transitions.

41. The method of claim 35, wherein each transition represents a permissible movement from one component to another component, each transition being associated with a triggering event.

42. The method of claim 41, wherein a triggering event includes receiving a user command, or expiry of a timer.

43. The method of claim 35, wherein the expanding step comprises:
creating from each one of the plurality of components one or more AV assets to provide the set of AV assets;
creating the expanded data structure wherein each node represents one AV asset of the set; and
creating a set of links between the nodes.

44. The method of claim 37, wherein the expanding step comprises evaluating each choice component to create a plurality of AV assets according to each value of the at least one parameter.

45. The method of claim 44, wherein evaluating each choice component comprises creating entry logic associated with at least one node and/or evaluating at least one transition to create exit logic associated with at least one node, and providing a link between a pair of nodes according to the entry logic and the exit logic.

46. The method of claim 35, comprising the step of checking expected conformance with the DVD-video format using the created components and transitions.

47. The method of claim 35, comprising the step of checking expected conformance with the DVD-video format using the set of AV assets and the expanded data structure of nodes and links.

48. An authoring method for use in creating an audiovisual product according to a DVD-video specification, comprising the steps of:
generating a set of AV assets each comprising a video object, zero or more audio objects and zero or more sub-picture objects, and an expanded data structure of nodes and links, where each node is associated with one AV asset of the set and the links represent navigational movement from one node to another; and
creating a DVD-video format data structure from the set of AV assets, using the nodes and links;
the method characterised by the steps of:
creating a plurality of components and a plurality of transitions, where a component implicitly defines a plurality of AV assets by referring to a presentation template and to items of raw content substitutable in the presentation template, and the plurality of transitions represent navigational movements between components; and
expanding the plurality of components and the plurality of transitions to generate the set of AV assets and the expanded data structure of nodes and links representing, or at least emulating, at least one menu.

49.

50. A method as claimed in claim 48 comprising the steps of providing a data structure comprising data defining a menu structure having at least one menu having a respective number of menu items associated with a number of defined views of, or actions in relation to, a general visual asset; providing a visual asset; and creating, automatically, a number of visual assets using at least one of the visual asset provided and the data of the data structure; the visual assets created corresponding to respective views of the defined views of the visual asset provided or reflecting respective actions of the defined actions in relation to the visual asset provided.

51. A method as claimed in claim 50 in which the step of providing the visual asset comprises the step of providing at least one of image data and a video sequence.

52. A method as claimed in claim 50 in which the step of creating the number of visual assets comprises the step of deriving data from the provided visual asset to produce the number of visual assets.

53. A method as claimed in claim 52 in which the step of deriving data from the provided visual asset comprises the step of copying data from the provided visual asset.

54. A method as claimed in claim 52 in which the step of deriving data from the provided visual asset comprises the step of processing the data of the visual asset such that the number of visual assets comprises respective modified data of the provided visual asset.

55. A method as claimed in claim 50 in which the step of creating the number of visual assets comprises the step of including, in selected visual assets of the number of visual assets, visual data representing views of selected menu items of the number of menu items.

56. A method as claimed in claim 50 in which the step of creating the number of visual assets comprises the step of creating sub-picture data comprising data for at least one selectable graphical element associated with a respective menu item.

57. A method as claimed in claim 56 in which the step of creating the sub-picture data comprises the step of creating, or providing, a number of selectable graphical elements associated with respective menu items.

58. A method as claimed in claim 57 in which the step of creating the sub-picture data comprises the step of creating a mask for selectively displaying the number of selectable graphical elements.

59. A method as claimed in claim 50 in which the step of creating the number of visual assets comprises the steps of associating a visual asset processing operation with selected menu items of the menu items; and deriving the data for the number of visual assets from the provided visual asset using respective visual asset processing operations.

60. A method as claimed in claim 50 in which the step of providing the data structure comprises the step of defining image data or video data associated with a plurality of views of the menu.

61. A method as claimed in claim 60 in which the step of defining image data or video data associated with the plurality of views of the menu comprises the step of creating image data or video data such that the plurality of views of the menu represent progressively expanding or contracting views of the menu.

62. A method as claimed in claim 50, further comprising the step of creating navigational data associated with, or linking, the number of visual assets according to the menu structure to allow the number of visual assets to be accessed, played or displayed according to the menu structure.

63. A method as claimed in claim 50, further comprising the step of providing a first number or plurality of visual assets; and creating, automatically, a second number of visual assets using the plurality of visual assets; the created visual assets corresponding to respective views of the defined views or to respective actions of the defined actions according to the menu structure.

64. A method as claimed in claim 50 in which the step of providing the visual assets comprises the step of providing an audio-visual asset.

65. (canceled).

66. An asset authoring system comprising means to provide a data structure comprising data defining a menu structure having at least one menu having a respective number of menu items associated with a number of defined views of, or actions in relation to, a general visual asset; means to provide a visual asset; means to create, automatically, a number of visual assets using at least one of the visual assets provided and the data of the data structure; the visual assets created corresponding to respective views of the defined views of the visual asset provided or reflecting respective actions of the defined actions in relation to the visual asset provided.

67. An asset authoring system as claimed in claim 66 in which the means to provide the visual asset comprises means to provide at least one of image data and a video sequence

68. A system as claimed in claim 66 in which the means to create the number of visual assets comprises means to derive data from the provided visual asset to produce the number of visual assets.

69. A system as claimed in claim 68 in which the means to derive data from the provided visual asset comprises means to copy data from the provided visual asset.

70. A system as claimed in claim 68 in which the means to derive data from the provided visual asset comprises means to process the data of the visual asset such that the number of visual assets comprises respective modified data of the provided visual asset.

71. A system as claimed in claim 66 in which the means to create the number of visual assets comprises means to include, in selected visual assets of the number of visual assets, visual data representing views of selected menu items of the number of menu items.

72. A system as claimed in claim 66 in which the means to create the number of visual assets comprises means to create sub-picture data comprising data for at least one selectable graphical element associated with a respective menu item.

73. A system as claimed in claim 72 in which the means to create the sub-picture data comprises means to create, or provide, a number of selectable graphical elements associated with respective menu items.

74. A system as claimed in claim 73 in which the means to create the sub-picture data comprises means to create a mask for selectively displaying the number of selectable graphical elements.

75. A system as claimed in claim 66 in which the means to create the number of visual assets comprises means to associate a visual asset processing operation with selected menu items of the menu items; and means to derive the data for the number of visual assets from the provided visual asset using respective visual asset processing operations.

76. A system as claimed in claim 66 in which the means to provide the data structure comprises means to define image data or video data associated with a plurality of views of the menu.

77. A system as claimed in claim 76 in which the means to define the image data or the video data associated with the plurality of views of the menu comprises the means to create the image data or the video data such that the plurality of views of the menu represent progressively expanding or contracting views of the menu.

78. A system as claimed in claim 66 further comprising means to create navigational data associated with, or linking, the number of visual assets according to the menu structure to allow the number of visual assets to be accessed, played or displayed according to the menu structure.

79. A system as claimed in claim 66 further comprising means to provide a first number or plurality of visual assets; and means to create, automatically, a second number of visual assets using the plurality of visual assets; the created visual assets corresponding to respective views of the defined views or to respective actions of the defined actions according to the menu structure.

80. An asset authoring system as claimed in claim 66 in which means to provide the visual assets comprises means to provide an audio-visual asset.

81. (canceled).

82. A system for authoring visual content, the system comprising means for creating a video sequence comprising data to display a progressively expanding menu comprising a number of menu items following invocation of a selected menu item or receipt of a user generated event and data derived from or associated with at least one of image data and a video sequence.

83. A system of authoring visual content, the system comprising means for creating a video sequence comprising data to display a progressively contracting menu comprising a number of menu items following invocation of a selected menu item or receipt of a user generated event.

84. A system as claimed in claim 83, further comprising means to generate sub-picture graphical elements for each menu item; each sub-picture graphical element having associated position data to position the elements in a predetermined position relative to corresponding menu items when rendered and data derived from or associated with at least one of image data or a video sequence.

85. A system as claimed in claim 82 in which the progressively varying menu represents a pull-down menu.

86. A computer program comprising computer executable code to implement a system or method as claimed in claim 1.

87. A product comprising computer readable storage storing a computer program as claimed in claim 86.

88. A storage medium comprising at least visual content authored using a method, system, computer program or product as claimed in claim 1.

89. A storage medium comprising data representing a video sequence comprising data to display a progressively variable or dynamic menu comprising a number of menu items following invocation of a selected menu item or receipt of a user generated event; and data representing sub-picture graphical elements for each menu item; each sub-picture graphical element having associated position data to mask the elements in predetermined positions relative to corresponding menu items when rendered in response to a user-generated event.

90. A storage medium as claimed in claim 89 in which the storage medium is an optical medium.

91. A storage medium as claimed in claim 90 in which the optical medium is a DVD product.

92. A storage medium as claimed in claim 89 in which the storage medium is a magnetic medium.

93. A storage medium as claimed in claim 92 in which the storage medium is a digital linear tape.

94. A system to manufacture a DVD product; the system comprising means to create a data carrier comprising data representing a video sequence comprising data to display a progressively variable or dynamic menu comprising a number of menu items following invocation of a selected menu item or receipt of a user generated event; and data representing sub-picture graphical elements for each menu item; each sub-picture graphical element having an associated maskable position relative to corresponding menu items when rendered in response to a user-generated event.

95. A system to manufacture a DVD product; the system comprising means to read a data carrier comprising data representing at least the set of visual assets created using a method, system, computer program, computer program product or storage medium as claimed in claim; and means to materially produce the DVD product using the data stored on the data carrier.

96. A DVD product comprising data representing a video sequence comprising data to display a progressively variable or dynamic menu comprising a number of menu items following invocation of a selected menu item or receipt of a user generated event; and data representing sub-picture graphical elements for each menu item; each sub-picture graphical element having an associated maskable position relative to corresponding menu items when rendered in response to a user-generated event.

97. (canceled).
